(19) United States
(12) Patent Application Publication
(10) Pub. No.: US 2025/0261825 A1
(43) Pub. Date: Aug. 21, 2025

(54) DISHWASHER

(71) Applicant: LG Electronics Inc., Seoul (KR)

(72) Inventors: Dongjun CHOI, Seoul (KR); Yeona JO, Seoul (KR); Yongnam KIM, Seoul (KR); Minkyu OH, Seoul (KR); Sangwoog CHO, Seoul (KR); Sunghyun PARK, Seoul (KR); Jinwon KANG, Seoul (KR)

(21) Appl. No.: 19/054,516

(22) Filed: Feb. 14, 2025

(30) Foreign Application Priority Data
Feb. 16, 2024 (KR) 10-2024-0022960
Apr. 24, 2024 (KR) 10-2024-0054645

(51) Int. Cl. A47L 15/42; E05B 5/00

(52) U.S. Cl. CPC A47L 15/4257; E05B 5/006

(57) ABSTRACT

A dishwasher includes a tub defining a washing chamber opened to a front side of the tub, a door configured to open and close the washing chamber, the door including a front face having an opening, a handle that is disposed at the door and defines a handle space connected to the opening of the door, and a handle cover disposed at the opening and configured to open and close the handle space based on rotating relative to the front face of the door. An upper portion of the handle cover is configured to move into the handle space, and a center of rotation of the handle cover is disposed below the opening of the door.

### CROSS-REFERENCE TO RELATED APPLICATIONS

This application claims priority to Korean Patent Application No. 10-2024-0022960, filed on Feb. 16, 2024, and Korean Patent Application No. 10-2024-0054645, filed on Apr. 24, 2024, the entire contents of which are hereby incorporated by reference in the present application.

### TECHNICAL FIELD

The present disclosure relates to a dishwasher, and more particularly, to a dishwasher with a handle.

### BACKGROUND

A dishwasher is a machine that removes food debris stuck on items to be washed, such as dishes loaded in a tub, and cleans the items by spraying water onto the items. The dishwasher can have a door that opens and closes the tub. The door can have a handle to allow the user to open and close the door.

In some cases, dishwashers may provide automatic opening and closing of the door after they finish washing. To allow the user to open the door, the dishwasher may have a handle regardless of the availability of the automatic door open and close function.

For example, the handle can have a space for the user's hand to slip in, where this space in the handle may be exposed to the outside to provide user access. In some cases, a dishwasher may include a door handle fitted to a door. The door handle may be rotatably fitted to the door, and the handle can have a durability issue since the user applies force to the handle to open the door.

In some cases, a dishwasher may include a control panel for opening and closing an entrance to a door handle. The center of rotation of the control panel may be located at a lower edge where the control panel and a handle space engage with each other, which may cause the central axis of rotation to be exposed to the outside when the control panel is opened. In some cases, control equipment may be provided at the rear of the control panel, where the angle to which the control panel opens the handle space may not be large enough to provide the handle.

In some cases, a dishwasher may have a recessed-type handle provided at a door and configured to be gripped by a user when opening or closing the door. For instance, the handle of the dishwasher may have the form of a grip recess that is recessed backward from a front face of the door to a predetermined depth.

### SUMMARY

The present disclosure describes a dishwasher with a handle cover for opening and closing a handle of a door.

In some implementations, the handle cover has an axis of rotation that is not exposed to the outside. For example, the axis of rotation of the handle cover can be located at a lower portion relative to an opening of the door. In some examples, the axis of rotation of the handle cover can be located inside an exterior of the door.

The present disclosure further describes a dishwasher in which a distance between the axis of rotation of the handle cover and a front face of the door is decreased. In some examples, the dishwasher allows the user easy access to the handle.

The present disclosure further describes a dishwasher that automatically opens and closes the handle cover. For example, the dishwasher can include a motor that provides a reduced motor torque to rotate the handle cover.

The present disclosure further describes a dishwasher that structurally allows the handle cover to rotate smoothly. For instance, components for rotating the handle cover are efficiently arranged in a narrow space inside the door. In some examples, the handle and the handle cover can extend longer in a width direction of the door than in a height direction of the door.

The present disclosure further describes a dishwasher that ensures that the handle cover opens at a large angle. The present disclosure further describes a dishwasher that can help prevent the user's fingers from getting caught in a handle cover that automatically opens and closes. The present disclosure further describes a dishwasher with a handle cover that can automatically open and close and that also can be manually opened and closed by the user. For instance, the motion of the handle cover may not be restrained by the motor when the user manually opens or closes the handle cover.

The present disclosure further describes a dishwasher that opens and closes by elasticity. In some implementations, the handle cover can open fast when opened and can close slowly when closed.

The present disclosure further describes a dishwasher that provides an aesthetic outward appearance.

Technical aspects to be accomplished by the disclosure are not limited to the above-mentioned technical aspects, and other technical aspects not mentioned herein will be clearly understood from the following description by those skilled in the art to which the disclosure pertains.

According to one aspect of the subject matter described in this application, a dishwasher includes a tub that defines a washing chamber, the washing chamber being opened to a front side of the tub, a door configured to open and close the washing chamber, the door including a front face having an opening, a handle that is disposed at the door and defines a handle space connected to the opening of the door, the handle space being defined rearward relative to the opening of the door, and a handle cover disposed at the opening of the door and configured to open and close the handle space based on rotating about a center of rotation relative to the front face of the door, the handle cover including an upper portion configured to move into the handle space based on the handle cover opening the handle space. The center of rotation of the handle cover is disposed below the opening of the door.

Implementations according to this aspect can include one or more of the following features. For example, the door can further include a door cover that defines the front face of the door, where the center of rotation of the handle cover is disposed rearward relative to the door cover. In some examples, the door cover can include a rim that defines a lower edge of the opening of the door and that is disposed above the center of rotation of the handle cover.

In some implementations, the handle cover can include a cover part configured to open and close the opening of the door, a shaft that defines the center of rotation of the handle cover, and a boss that accommodates the shaft, where the rim is disposed vertically above the boss and covers at least a part of the boss. In some examples, the handle cover can define a recess at a lower end of the cover part, where the rim is configured to insert into the recess of the handle cover based on the handle cover closing the handle space such that a front face of the handle cover and the front face of the door cover are coplanar.

In some implementations, the dishwasher can further include a driving unit configured to rotate the handle cover relative to the door, where the driving unit includes a link that is rotatably connected to the handle cover and spaced apart from the center of rotation of the handle cover. In some examples, the driving unit can further include a motor and a connector that is connected to the link and configured to be rotated by the motor.

In some examples, the handle cover can be configured to, based on the handle cover opening the handle space, define an angle between the handle cover and the link, where the angle is smaller than 90 degrees. In some examples, a center of rotation of the connector can be disposed between a motor shaft of the motor and the center of rotation of the handle cover in a vertical direction and in a front-rear direction.

In some implementations, the dishwasher can include a driving unit configured to rotate the handle cover, the driving unit including a motor disposed below the handle cover, where the handle cover extends in a width direction of the door. Lateral ends of the handle cover in the width direction can define lateral ends of the door, respectively, or the handle cover can extend toward the lateral ends of the door that are spaced apart from the lateral ends of the handle cover. In some examples, a length of the driving unit in the width direction of the door is greater than a distance between one of the lateral ends of the door and one of the lateral ends of the handle cover.

In some implementations, the dishwasher can include a spring configured to apply elastic force to the handle cover to thereby cause the handle cover to close the handle space, where one of the lateral ends of the handle cover and one of the lateral ends of the door are spaced apart from each other, and the spring is disposed between the one of the lateral ends of the handle cover and the one of the lateral ends of the door.

In some implementations, the dishwasher can include a door cover that defines the front face of the door, where the handle cover includes a decoration disposed at a front side of the handle cover, and the decoration and the door cover are made of a same material and configured to be coplanar based on the handle cover closing the handle space.

In some implementations, the handle can include a housing that is disposed inside the door and defines the handle space, where the handle cover is rotatably attached to the housing. For instance, the housing can include a side wall and a guide that has an arc shape and is defined at the side wall, where the handle cover includes a cover part configured to be disposed at the opening of the door based on the handle cover closing the handle space, and a slider that is disposed at the cover part and configured to move along the guide.

According to another aspect, a dishwasher includes a tub that defines a washing chamber, the washing chamber being opened to a front side of the tub, a door configured to open and close the washing chamber, the door including a front face having an opening, a handle that is disposed at the door and defines a handle space connected to the opening of the door, the handle space being defined rearward relative to the opening of the door, a handle cover disposed at the opening of the door and configured to open and close the handle space based on rotating relative to the front face of the door, the handle cover including an upper portion configured to move into the handle space based on the handle cover opening the handle space, and a driving unit configured to rotate the handle cover, the driving unit including a motor disposed below the handle cover.

Implementations according to this aspect can include one or more of the following features. For example, the handle can further include a housing that is disposed inside the door and defines the handle space, where the driving unit is disposed below the housing. In some implementations, the housing can include a bottom face configured to face a rear face of the handle cover based on the handle cover opening the handle space, the bottom face defining a through-hole, where the driving unit can further include a link that passes through the through-hole and is connected to the handle cover.

In some implementations, the housing further includes a bottom face configured to face a rear face of the handle cover based on the handle cover opening the handle space, a stepped portion disposed below a front end of the bottom face, and a shaft holder that protrudes from the stepped portion, the shaft holder supporting a portion of the handle cover that defines an axis of rotation of the handle cover.

According to another aspect, a dishwasher includes a tub that defines a washing chamber, the washing chamber being opened to a front side of the tub, a door configured to open and close the washing chamber, the door including a front face having an opening, a handle housing that is disposed at the door and defines a handle space connected to the opening of the door, the handle space being defined rearward relative to the opening of the door, a handle cover disposed at the opening of the door and configured to open and close the handle space based on rotating relative to the front face of the door in a first direction and a second direction, respectively, the handle cover including an upper portion configured to move into the handle space based on the handle cover opening the handle space, and a driving system configured to rotate the handle cover. The driving system includes a motor disposed below the handle housing and configured to rotate the handle cover in the first direction, and a spring disposed at an outer side of the handle housing in a width direction of the door and configured to apply force to the handle cover in the second direction opposite to the first direction.

Implementations according to this aspect can include one or more of the following features. For example, the driving system can further include a driving unit that rotates the handle cover and that includes the motor.

In some examples, the driving unit can include a pinion that is coupled to a motor shaft of the motor and rotates integrally with the motor shaft. In some examples, the driving unit can include an actuator configured to be rotated by the motor. In some examples, the driving unit can include a connector that is configured to be rotate by the motor. For example, the connector can include a lever that abuts the actuator.

In some examples, the connector can rotate the handle cover. The connector can be connected to the handle cover so as to rotate when the handle cover rotates. For example, the lever part can be disposed in the first direction with respect to the actuator. The lever part can rotate with the actuator when the actuator rotates in the first direction. The connector may not be restrained by the actuator when the handle cover rotates in the first direction.

In some implementations, the connector can have a space that extends in the second direction opposite to the first direction, from the lever part with respect to the center of rotation of the actuator. In some examples, the connector can include a body having the lever part, and a recess extending in the second direction opposite to the first direction from the lever part with respect to the center of rotation of the actuator, into which the actuator is inserted.

In some examples, the actuator can include a first gear part which meshes with the pinion. For example, the first gear part can be positioned forward relative to the pinion. In some examples, the actuator can include an arm that extends outward of the first gear part along the radius of rotation of the actuator, where the arm can rotate integrally with the first gear part. In some examples, the actuator can include a finger that is inserted into the connector recess. The finger can protrude from the arm.

In some examples, the driving unit can include a driving unit shaft that provides the centers of rotation of the connector and the actuator. The driving unit shaft can penetrate the connector and the actuator. For example, the driving unit can include a link connected to the handle cover. The driving unit can include a link rotatably connected to the handle cover. The link can be connected to the handle cover at a position spaced apart in a radial direction from the center of rotation of the handle cover.

In some examples, the link can have a first connecting portion to be connected to the handle cover and a second connecting portion to be connected to the connector. For example, the first connecting portion can be connected to the handle cover at a position spaced apart in the radial direction from the center of rotation of the handle cover.

In some implementations, the dishwasher can further include a bracket that is coupled to the handle cover and connected to the first connecting portion of the link. The first connecting portion can be rotatably coupled to the bracket. The bracket can be spaced apart in the radial direction from the center of rotation of the handle cover.

In some examples, the angle between the handle cover and the link can be smaller than 90 degrees when the handle cover is open. For example, the angle between the handle cover and the link can be smaller than 90 degrees in the process in which the handle cover rotates between closed state and open state.

In some examples, the connector can be connected to the link. The connector can include a joint that extends from the body and is connected to the second connecting portion. The second connecting portion can be rotatably coupled to the joint.

The center of rotation of the connector can be disposed vertically between the motor shaft of the motor and the center of rotation of the handle cover. The center of rotation of the connector can be disposed between the motor shaft of the motor and the center of rotation of the handle cover in a front-rear direction.

In some examples, the connector can include a second gear part. For example, the second gear part can be disposed on an outer side of the body. In some examples, the driving system can include a rotary damper that meshes with the second gear part of the connector.

For example, the rotary damper can be a unidirectional damper which applies force to the connector in the second direction opposite to the first direction when the connector rotates in the first direction. The rotary damper can be a bidirectional damper which applies force to the connector in the first direction when the connector rotates in the second direction.

In some examples, the spring can be disposed between a lateral end of the handle cover and a lateral end of the door. In some examples, the housing of the handle can include a spring housing disposed on an outer side of the handle cover in the width direction of the door. The spring housing can accommodate the spring.

In some examples, the handle cover can include a handle cover shaft that provides the center of rotation of the handle cover. The handle cover shaft can extend in the width direction of the door. The handle cover shaft can penetrate a side wall of the housing.

In some examples, the driving system can include a holder to be connected to the spring. The holder can be coupled to the handle cover shaft and rotate with the handle cover shaft. The holder can be disposed at the spring housing. The handle cover can be rotatably coupled to the housing.

In some implementations, the driving system can include: a motor, an actuator that rotates by the motor to rotate the handle cover in the first direction; and a strap that connects the actuator and the handle cover and bends by an external force when the handle cover rotates in the first direction while the motor is stopped.

In some implementations, the cover part can be connected to the door in such a way as to be rotatable between a foremost position in which the cover part is maximally rotated forward and a rearmost position in which the cover part is maximally rotated rearward.

In some examples, when the cover part is moved to the foremost position, the opening can be closed off by the cover part. In some examples, when the cover part is moved to the foremost position, no stepped portion may be formed between a front end face of the cover part and the front face of the door. In some examples, the front end face of the cover part can have a surface that has the same texture as the front face of the door. In some examples, when the cover part is moved to the rearmost position, the opening can be fully opened.

In some implementations, the dishwasher can include: a return spring that exerts restorative force to the cover part so that the cover part rotates to the foremost position; and a driving unit that prevents or allows the rotation of the cover part to the foremost position by the return spring, in conjunction with the angle of rotation of the door.

In some examples, the door can be rotatably disposed between a closed position in which the open front face of the tub is closed and a fully open position in which the open front face of the tub is fully open, and when the door is rotated less than the angle of rotation for a cover release position which is defined between the closed position and the fully open position, the driving unit can prevent the cover part from rotating to the foremost position.

In some examples, when the door is rotated by an angle greater than or equal to the angle of rotation for the cover release position, the driving unit can allow the cover part to rotate to the foremost position. For example, the angle of rotation for the cover release position can range from 45 to 55 degrees.

In some examples, the driving unit can include: a rack gear that is connected to the cover part and rotates with the cover part; a first pinion gear that engages the first gear portion of the rack gear and rotates in a direction opposite to the rack gear; a second pinion gear that engages the first pinion gear and rotates in the same direction as the rack gear; a shaft that rotatably supports the second pinion gear; a one-way clutch that regulates a connection between the second pinion gear and the shaft; a ratchet gear that is rotatably supported on the shaft and rotates integrally with the shaft; and a latch link that is configured to rotate about an axis of rotation disposed at a position spaced downward apart from the shaft, and that engages or disengages the ratchet gear in conjunction with the angle of rotation of the door.

In some examples, when the cover part rotates rearward, the one-way clutch can prevent a torque of the second pinion gear from being transmitted to the shaft, and when the cover part rotates forward, the one-way clutch can allow the torque of the second pinion gear to be transmitted to the shaft.

In some examples, the latch link can further include a weight balance disposed opposite the latch portion with respect to the axis of rotation, wherein the entire center of mass of the latch link can be formed on the weight balance.

In some examples, when the door is in closed position, a virtual extended line connecting the axis of rotation of the latch link and the center of mass can form a predetermined intersecting angle with respect to a vertical direction, and the predetermined intersecting angle can be greater or equal to the angle of rotation for the cover release position.

In some examples, the driving unit can further include a rotary damper that reduces the rotational speed of the rack gear, wherein the rack gear can have a second gear portion that engages a damper gear of the rotary damper. In some examples, the return spring can include a torsion spring, one end of which is connected to the door, and the other end of which is connected to the cover part.

### BRIEF DESCRIPTION OF THE DRAWINGS

FIG. 1 is a perspective view showing an example of a dishwasher.

FIG. 2 is a perspective view showing an example of an open state of a door of the dishwasher.

FIG. 3 is a schematic view showing an example of an interior of the dishwasher.

FIG. 4 is a perspective view showing the door of the dishwasher in FIG. 1 when a handle cover is open.

FIGS. 5A and 5B are cross-sectional views of the door illustrated in FIG. 4 and illustrates the handle cover and a driving unit.

FIG. 6 is a perspective view illustrating an example of a handle housing and the handle cover in the handle illustrated in FIGS. 5A and 5B.

FIG. 7 is a perspective view showing an interior of the door of the dishwasher when viewed from the rear.

FIG. 8 is an exploded perspective view showing the driving unit of the dishwasher illustrated in FIG. 7.

FIGS. 9A to 9C are schematic views showing how the driving unit illustrated in FIG. 8 operates, in which FIG. 9A depicts the handle closed by the handle cover, FIG. 9B depicts the handle opened by the driving unit by rotating the handle cover, and FIG. 9C depicts that the driving unit is rotating the handle cover in a direction that closes the handle when the handle cover is open, before the handle cover closes the handle.

FIGS. 10A to 10C are cross-sectional views showing how the driving unit illustrated in FIGS. 9A to 9C operates.

FIGS. 11A and 11B are schematic views showing an example operation in which the handle cover opens while the driving unit is stopped, in which FIG. 11A depicts the handle closed by the handle cover, and FIG. 11B depicts that the handle cover is open while the driving unit is stopped.

FIGS. 12A and 12B are cross-sectional views showing how the driving unit illustrated in FIGS. 11A and 11B operates.

FIG. 13 is a cross-sectional view showing how the handle cover, the link, and the connector are connected to one another while the handle cover is open.

FIG. 14 is a cross-sectional view showing an example of a handle cover and driving unit of an example of a dishwasher.

FIGS. 15A and 15B are cross-sectional views showing an example of a driving unit of a dishwasher, in which FIG. 15A depicts the handle closed by the handle cover, and FIG. 15B depicts the handle opened by the driving unit by rotating the handle cover.

FIG. 16 is a cross-sectional view showing that the handle cover is in open state while the driving unit of the dishwasher disclosed in FIGS. 15A and 15B is stopped.

FIGS. 17 and 18 are cross-sectional perspective views showing an example of a handle cover and driving unit of a dishwasher.

FIG. 19 is a rear perspective view of the driving unit of FIGS. 17 and 18.

FIG. 20 is an exploded perspective view of the driving unit illustrated in FIG. 19.

FIG. 21 is a side view illustrating an example of a driving unit which allows rearward rotation of a cover part by an external force but prevents forward rotation thereof, when the door is in closed position.

FIG. 22 is a side view illustrating an example of a driving unit which allows forward rotation of the cover part when the door reaches a cover release position.

FIG. 23 is a partial enlarged view of FIG. 21, which is a view for explaining the relative angles of placement and rotation of the ratchet gear and latch link of the driving unit while the cover part is prevented from rotating forward.

FIG. 24 is a partial enlarged view of FIG. 22, which is a view for explaining the relative angles of placement and rotation of the ratchet gear and latch link of the driving unit while the cover part is allowed to rotate forward.

FIG. 25 and FIG. 26 are partial exploded views of a ratchet gear and a latch link, for explaining a structure in which the ratchet gear and a latch portion of the latch link engage each other.

### DETAILED DESCRIPTION

Hereinafter, one or more implementations of the present specification will be described in detail with reference to the accompanying drawings, but the same or similar components are assigned the same reference numerals regardless of reference numerals, and overlapping descriptions thereof will be omitted.

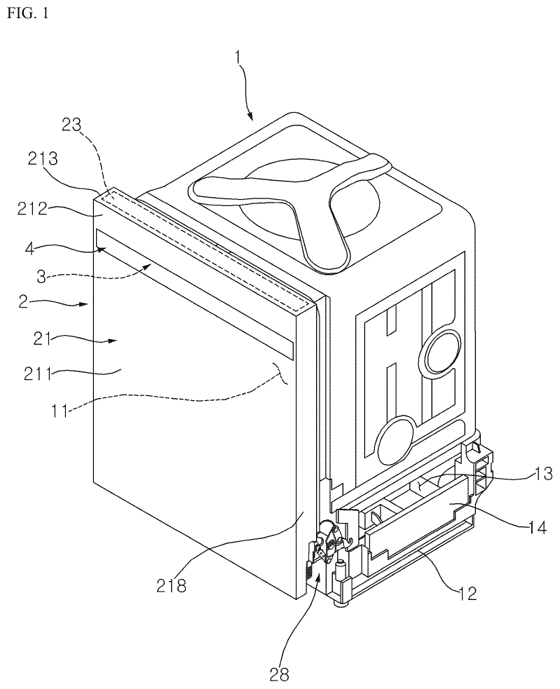

Referring to FIG. 1, the dishwasher includes a tub 1. The tub 1 can provide a washing chamber 11. The washing chamber 11 can be provided inside the tub 1.

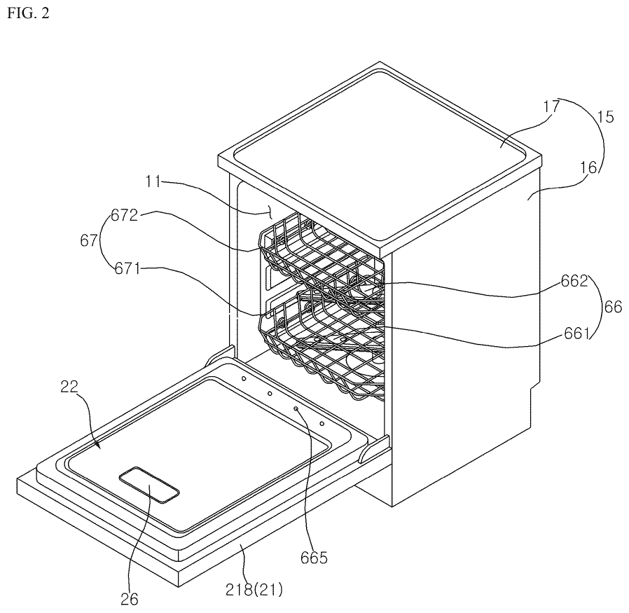

The tub 1 can have the shape of a hexahedron whose one side is open (see FIG. 2). The front of the tub 1 can be open.

The washing chamber 11 can open to the front (see FIG. 2). A direction from the opening of the washing chamber 11 toward the rear, that is, a front-rear direction, can be referred to as a depth direction of the washing chamber 11.

The dishwasher can include a door 2 that opens up and closes off the washing chamber 11. The door 2 can be disposed at the front of the tub 1. The door 2 can be rotatably coupled to the front of the tub 1.

A bottom of the door 2 can be coupled to the tub 1. The door 2 can be hinged to a front bottom portion of the tub 1. The dishwasher can include a hinge 28 that rotatably attaches the door 2 to the tub 1.

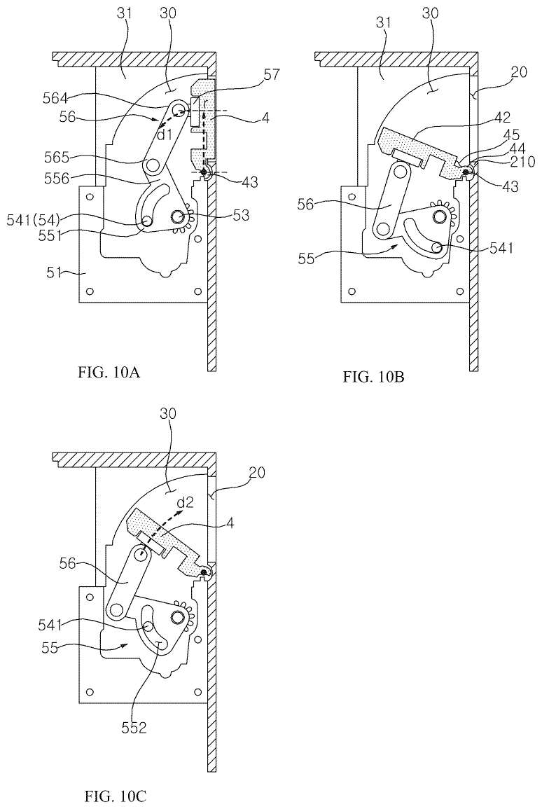

The door 2 can open in such a way that a top portion of the door 2 faces forward (see FIG. 2). The door 2 can rotate in a first direction d1 (see FIGS. 10A to 10C) to be described later in which a handle cover 4 opens, thereby closing off the tub 1. The door 2 can rotate in a second direction d2 (see FIGS. 10A to 10C) to be described later in which the handle cover 4 closes, thereby opening up the tub 1.

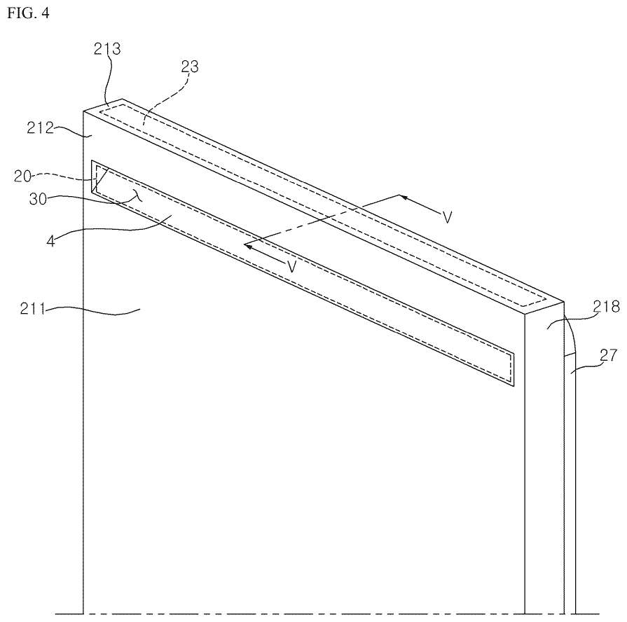

The door 2 can include a front face 211. An opening 20 (see FIG. 4) can be provided on the front face 211 of the door 2.

The door 2 can include a door cover 21. The door cover 21 can provide the front face 211 of the door 2. The door cover 21 can provide a lateral face 218 of the door 2. The door cover 21 can provide a top face 213 of the door 2.

The dishwasher can include a handle 3. The handle 3 can provide a space that connects to the opening 20 of the door 2. The handle 3 can be disposed at the rear of the opening 20.

The handle 3 can be disposed at the front of the door 2. The handle 3 can be disposed at an upper portion of the door 2. The handle 3 can be disposed at an upper portion of the front face 211 of the door 2. An upper portion 212 of the front face 211 of the door 2 can be disposed above the handle 3.

The dishwasher can include a handle cover 4. The handle cover 4 can open and close the handle 3.

The dishwasher can include a base 12. The base 12 can provide a bottom surface of the dishwasher.

The bottom of the tub 1 can be spaced upward from the base 12. A machine chamber 13 can be provided between the bottom of the tub 1 and the base 12. Components like a controller 14 (e.g., a printed circuit board (PCB)), a sump 61 to be described later, and a pump 62 can be disposed in the machine chamber 13.

An interface 23 can be disposed at the top of the door 2. The interface 23 can be disposed on the top face 213 of the door.

The interface 23 can receive input commands from the user. The interface 23 can provide the user with information related to the dishwasher.

For example, the user can enter commands relating to a washing stroke and washing options via the interface 23. For example, the interface 23 can show information on a washing stroke and washing options.

The controller 14 can control the dishwasher. The controller 14 can receive input commands from the user via the interface 23. The controller 14 can provide the user with information on the dishwasher via the interface 23.

Hereinafter, the components to be described below can be controlled by the controller 14.

Referring to FIG. 2, the dishwasher can further include a casing 15. The casing 15 can be disposed outside the tub 1.

The casing 15 can include a cabinet 16 and a top plate 17. The cabinet 16 can cover a side wall of the tub 1. The top plate 17 can cover a top face of the tub 1.

As stated above, the washing chamber 11 can open forward, and the door 2 can open up and close off the washing chamber 11.

The dishwasher can include racks 67 disposed in the washing chamber 11. Items to be cleaned, such as cookware, dishware, and cutlery, can be placed on the racks 67.

The racks 67 can include a first rack 671. The first rack 671 can be disposed at a lower portion of the washing chamber 11.

The racks 67 can include a second rack 672 disposed above the first rack 671. The height at which the second rack 672 is disposed can be adjusted.

The dishwasher can include spray arms 661 and 662. The spray arms 661 and 662 can spray wash water toward the racks 67.

The spray arms 661 and 662 can be disposed under the racks 67. The spray arms 661 and 662 can spray wash water toward the top.

The spray arms 661 and 662 can include a first spray arm 661. The first spray arm 661 can be disposed under the first rack 671.

The spray arms 661 and 662 can include a second spray arm 662. The second spray arm 662 can be disposed below the second rack 672.

The door 2 can be opened in such a way that the upper portion of the door 2 faces forward. The door 2 can rotate in the second direction d2 (see FIGS. 10A to 10C) to be described later in which the handle cover 4 closes the handle 3, thereby opening up the tub 1.

The door 2 can include an inner panel 22. The inner panel 22 can face upward while the door 2 is open. When the user places items to be cleaned in the rack, water dripping from these items or the rack can drop to the inner panel 22.

The dishwasher can include a steam nozzle 665. The steam nozzle 665 can be provided on the door 2. The steam nozzle 665 can be provided on the inner panel 22.

The dishwasher can include a dispenser 26. The dispenser 26 can be provided on the inner panel 22.

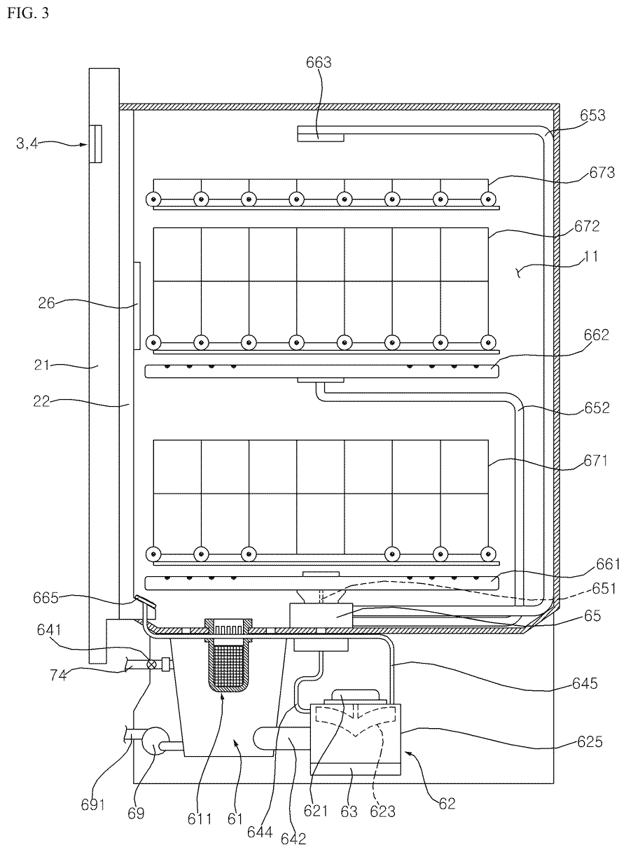

Referring to FIG. 3, the racks 67 can be pulled out forward from the washing chamber 11. The racks 67 can be pushed in and disposed in the washing chamber 11.

The racks 67 can include a third rack 673. The third rack 673 can be disposed above the first rack 671. The third rack 673 can be disposed above the second rack 672. The third rack 673 can be disposed at the uppermost position among the plurality of racks 67.

The spray arms 661 and 662 can include a nozzle. The nozzle can spray wash water.

The spray arms 661 and 662 can be rotatably provided.

The first spray arm 661 can be disposed under the first rack 671. The first spray arm 661 can spray wash water toward the first rack 671.

The first spray arm 661 can be rotatably provided. The first spray arm 661 can be rotated by a motor. Alternatively, the first spray arm 661 can rotate by the reaction force of wash water sprayed a first nozzle 6613 from.

The second spray arm 662 can be disposed under the second rack 672. The second spray arm 662 can be coupled to the second rack 672. The second spray arm 662 can spray wash water toward the second rack 672.

The second spray arm 662 can be rotatably provided. The second spray arm 662 can rotate by the reaction force of wash water is sprayed from a second nozzle 6623.

Alternatively, the second spray arm 662 can be rotated by a motor.

The dishwasher can include a top nozzle 663. The top nozzle 663 can be disposed above the racks 67. The top nozzle 663 can be disposed at the ceiling of the washing chamber 11. The top nozzle 663 can spray wash water toward the bottom. The top nozzle 663 can spray wash water toward the racks 67. The top nozzle 663 can spray wash water toward the third rack 33.

The door 2 can include a door cover 21. The door cover 21 can be exposed to the outside while the door 2 closes off the washing chamber 11.

The door 2 can include an inner panel 22. The inner panel 22 can face toward the washing chamber 11 while the door 2 closes off the washing chamber 11. The inner panel 22 can provide a front face of the washing chamber 11 while the door 2 closes off the washing chamber 11.

The dishwasher can include a dispenser 26. The dispenser 26 can contain a detergent. The dispenser 26 can contain a tablet-type detergent. Alternatively, the dispenser 26 can receive a powder-type detergent.

In some examples, some of the nozzles of the spray arms 661 and 662 can face toward the dispenser 26 disposed at the door 2.

The dishwasher can supply steam to the washing chamber 11. A steam nozzle 665 can supply steam to the washing chamber 11. The steam nozzle 665 can be disposed at the front of the washing chamber 11 and supply steam toward the rear. The steam nozzle 665 can be disposed at a lower portion of the washing chamber 11 and supply steam toward the top. The steam nozzle 665 can be disposed at a front lower portion of the washing chamber 11 and supply steam toward the top rear.

The steam nozzle 665 can be disposed at the door 2. The steam nozzle 665 can be provided on the inner panel 22. The steam nozzle 665 can be disposed at a lower portion of the inner panel 22. The steam nozzle 665 can be slanted off the horizontal.

The dishwasher can include a sump 61. The sump 61 can be supplied with water from an external water source such as a tap. The sump 61 can store the water supplied from the outside.

The sump 61 can be supplied with water from an external water source through a water supply tube 64. The water supply tube 64 can be connected to the external water source.

The water supply tube 64 can connect the external water source and the sump 61.

The water supply valve 641 can regulate the water supply tube 64. The water supply tube 64 can control the flow of water running from an external water source to the sump 61.

The sump 61 can be provided beneath the tub 1. The sump 61 can be disposed under the bottom of the tub 1. The sump 61 can be disposed in the machine chamber. The sump 61 can be connected to the bottom of the tub 1 and disposed in the machine chamber.

The sump 61 can store water drained from the washing chamber 11.

The dishwasher can include a filter 611. The filter 611 can filter out impurities from the water flowing from the washing chamber 11 to the sump 61. The filter 611 can be disposed in the sump 61.

The dishwasher can include a pump 62 that supplies wash water to the washing chamber 11. The pump 62 can pump water out of the sump 61. The pump 62 can pump water and supply the water to the spray arms 661 and 662. The pump 62 can pump water and supply the water to the top nozzle 663.

The pump 62 can include an impeller 623, a pump housing 625 holding the impeller 623, and a washing motor 621 that rotates the impeller 623. The washing motor 621 can be a motor that can vary in rotational speed. For example, the washing motor 621 can be a brushless DC (BLDC) motor.

The dishwasher can include a heater 63 that heats wash water. The heater 63 can be connected to the pump 62. The heater 63 can heat the water drawn into the pump 62.

A switching valve 65 can be connected to the washing pump 62. The switching valve 65 can be supplied with wash water from the pump 62.

The switching valve 65 can be connected to the spray arms 661 and 662 and the top nozzle 663. The switching valve 65 can distribute wash water. The switching valve 65 can selectively supply wash water to at least one of the first spray arm 661, the second spray arm 662, and the top nozzle 663.

A pump intake tube 642 can connect the sump 61 and the pump 62. When the pump 62 is actuated, the water in the sump 61 can enter the pump 62 through the intake tube 642.

A discharge tube 644 can be connected to the pump 62. The discharge tube 644 can guide the water discharged from the pump 62 toward the spray arms 661 and 662 and the top nozzle 663.

The discharge tube 644 can be connected to the switching valve 65. The discharge tube 644 can connect the pump 62 and the switching valve 65.

Connecting tubes 651, 652, and 653 can connect the spray arms 661 and 662 and the top nozzle 663 to the switching valve 65.

The connecting tubes 651, 652, and 653 can include a first connecting tube 651 connected to the first spray arm 661. The first connecting tube 651 can be provided inside the first spray arm 661.

The connecting tubes 651, 652, and 653 can include a second connecting tube 652 connected to the second spray arm 662. The second connecting tube 652 can be provided on a rear wall of the tub 1.

The connecting tubes 651, 652, and 653 can include a third connecting tube 653 connected to the top nozzle 663. The third connecting tube 653 can be provided on an upper surface 114 of the tub 1.

When the pump 62 is actuated, the wash water discharged from the pump 62 can enter the switching valve 65. The wash water drawn into the switching valve 65 can flow to at least one of the plurality of connecting tubes 651, 652, and 653 by the switching valve 65.

Once the wash water has flowed to the first connecting tube 651, the wash water can be sprayed from the first nozzle 6613 of the first spray arm 661. Once the wash water has flowed to the second connecting tube 652, the wash water can be sprayed from the second nozzle 6623 of the second spray arm 662. Once the wash water has flowed to the third connecting tube 653, the wash water can be sprayed from the top nozzle 663.

The wash water sprayed to the washing chamber 11 collects at the bottom and enters the sump 61. The wash water drawn into the sump 61 can be sprayed to the washing chamber 11 by the pump 62 and re-circulated.

The sump 61 can be connected to a drainage pump 69. A drainage tube can connect the sump 61 and the drainage pump 69. When the drainage pump 69 is actuated, the water in the sump 61 can be drained out of the dishwasher.

Referring to FIG. 4, a dishwasher includes a door 2, a handle 3 provided on the door 2, and a handle cover 4 for opening and closing the handle 3.

The door 2 can include a door cover 21 that provides a front face 211, a top face 213, and a lateral face 218. The front face 211 of the door 2 can include an upper portion 212 disposed on an upper side of the handle 3.

An interface 23 can be disposed on the top face 213 of the door 2.

The door 2 can include an inner panel 27. The inner panel 27 can be shorter in a lateral direction than the door cover 21. Hereinafter, the lateral direction also can refer to the width direction of the door 2.

The front face 211 of the door 2 can have an opening 20.

The handle 3 can be disposed at the rear of the opening 20. The handle 3 can have a handle space 30 that connects to the opening 20.

In some examples, the opening 20 can refer to a part of the handle space 30 of the handle 3, e.g., a front end of the handle space 30. The opening 20 can refer to a portion disposed in the same plane as the front face 211 of the door 2.

For example, the handle cover 4 of FIG. 1 is in closed state, and the handle cover 4 of FIG. 4 is in open state.

The handle cover 4 can close off the handle space 30 of the handle 3 (see FIG. 1). The handle cover 4 can be disposed at the opening 20 and close off the handle space 30 of the handle 3.

The handle cover 4 can open up the handle space 30 of the handle 3. The handle cover 4 can rotate in the first direction d1 (see FIGS. 10A to 10C) so as to get into the handle space 30 of the handle 3. The handle cover 4 can rotate in the first direction d1 to open up the handle space 30 of the handle 3.

The axis of rotation of the handle cover 4 can be located at a lower side or lower portion of the handle cover 4.

The handle cover 4 can rotate such that an upper portion of the handle cover 4 gets into the handle space 30 of the handle 3. The handle cover 4 can rotate and open up the handle space 30 such that an upper portion of the handle cover 4 gets into the handle space 30 of the handle 3.

The handle 3 can extend in the width direction of the door 2. Opposite ends of the handle 3 can be contiguous to the lateral face 218 of the door 2. Alternatively, the handle 3 can extend all the way to the lateral face 218 of the door 2.

The handle cover 4 can extend in the width direction of the door 2. Opposite ends of the handle cover 4 can be contiguous to the lateral face 218 of the door 2. Alternatively, the handle cover 4 can extend all the way to the lateral face 218 of the door 2.

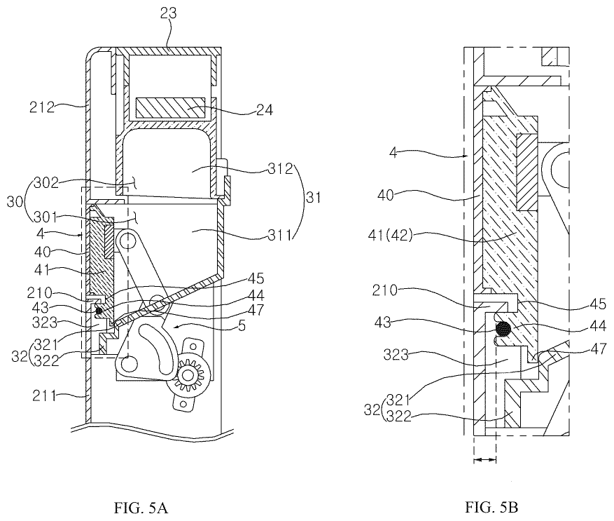

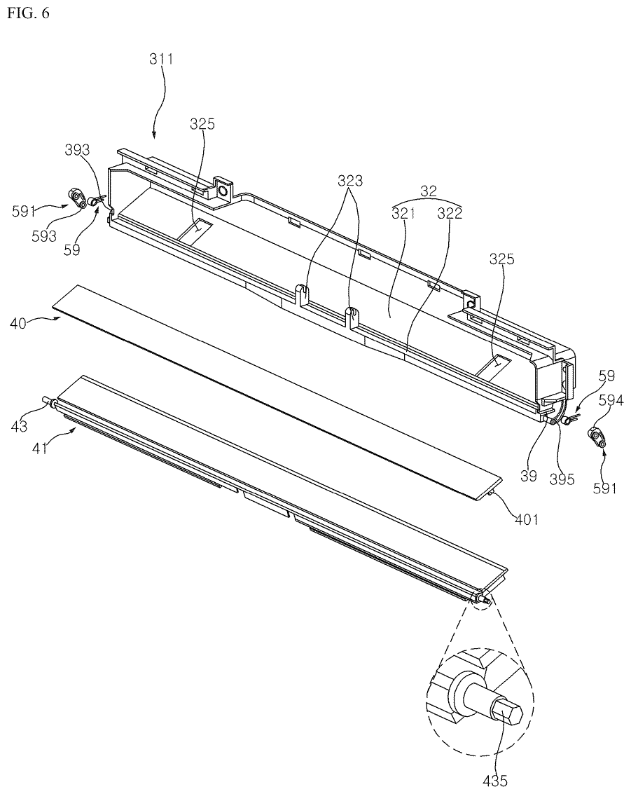

Referring to FIGS. 5A and 5B and FIG. 6, the center of rotation of the handle cover 4 can be positioned at a lower side or lower portion of the handle cover 4.

The handle cover 4 can include a cover part 42 that closes the handle space 30. The cover part 42 can be disposed at the opening 20 (see FIG. 4) and close the handle space 30.

The handle cover 4 can include a boss 44 that encloses a shaft 43 that provides the center of rotation of the handle cover 4. The boss 44 can extend downward from the cover part 42.

The front surface of the cover part 42 can be positioned further forward than the front portion of the boss 44. The front surface of the cover part 42 can be positioned further forward than the rotation center (e.g., shaft 43) of the handle cover 4.

The front surface of the cover part 42 can be aligned on the same plane as the front face 211 of the door cover 21. The rotation center (e.g., shaft 43) of the handle cover 4 can be positioned behind the front face 211 of the door cover 21.

The cover part 42 can include a decoration 40, which will be described later. The decoration 40 can form the front surface of the cover part 42. The decoration 40 can be aligned on the same plane as the front face 211 of the door cover 21.

A rearward recess 45 can be disposed between the boss 44 and the cover part 42.

The door cover 21 can include a rim 210 that forms not the upper portion 212 but an upper edge of the front face 211 located under the opening 20. The rim 210 can form a lower edge or lower periphery of the opening 20. The rim 210 can extend rearward from the upper edge of the front face 211.

The center (e.g., shaft 43) of rotation of the handle cover 4 can be positioned lower than the opening 20 of the door 2. The center of rotation of the handle cover 4 can be positioned at the rear of the door cover 21.

The rim 210 can be positioned higher than the center (e.g., shaft 43) of rotation of the handle cover 4. The rim 210 can be positioned vertically above at least part of the boss 44. The rim 210 can enclose at least part of the boss 44.

The axis (e.g., shaft 43) of rotation of the handle cover 4 may not be exposed to the outside through the opening 20.

The rim 210 can be inserted into the recess 45 of the handle cover 4. The rim 210 can be inserted into the recess 45 of the handle cover 4 while the handle cover 4 closes the handle 3.

The handle 3 can be disposed inside the door 2.

The handle 3 can further include a housing 31 that defines a handle space 30 of the handle 3.

The housing 31 can be disposed in the door 2. The housing 31 can be disposed inside the door 2.

The housing 31 can provide a handle space 30 that connects to the opening 20 of the door 2. The housing 31 can be disposed at the rear of the opening 20.

The housing 31 can include a first housing 311 that is disposed at the rear of the opening 20. The first housing 311 can provide a first recess 301 that connects to the opening 20 and is disposed at the rear of the opening 20.

The housing 31 can include a second housing 312 that is disposed above the first housing 311. The second housing 312 can provide a second recess 302 that is disposed above the first recess 301 and connects to the first recess 301.

The first recess 301 can extend all the way to opposite ends of the housing 31 in the width direction of the door 2. The second recess 302 can extend a shorter distance than the first recess 301 in the width direction of the door 2. The second recess 302 can be disposed midway along the width of the door 2.

An interface 23 and an interface controller 24 can be disposed above the second housing 312.

The handle cover 4 can be rotatably coupled to the housing 31. The housing 31 can include a shaft holder 323 that supports the shaft 43 of the handle cover 4. The housing 31 can include a shaft hole 393 (see FIG. 6) that supports the shaft 43 of the handle cover 4.

The dishwasher can include a driving system 5 for rotating the handle cover 4. The driving system 5 can include a motor and a driving unit 50 to be actuated by the motor.

The driving unit 50 can be positioned under the housing 31.

The housing 31 can include a bottom 32. The bottom 32 can include a bottom face 321. The bottom face 321 can face a rear face of the handle cover 4 when the handle cover 4 is open.

The bottom face 321 can be slanted in such a way that the rear is positioned higher.

The driving unit 50 can be positioned under the bottom face 321, and some of the components thereof can pass through a through-hole 325 and be connected to the handle cover 4.

When the handle cover 4 is opened, the driving unit 50 may not be placed between the handle cover 4 and the bottom face 321, but instead the handle cover 4 and the bottom face 321 can come into contact with each other or be contiguous to each other.

The housing 31 can include a through-hole 325 formed in the bottom face 321.

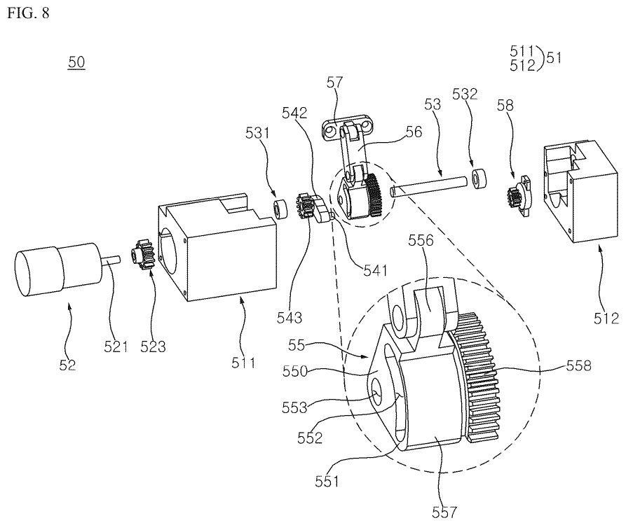

A link 56 (see FIG. 8) of the driving unit 50 to be described later can pass through the through-hole 325 and be connected to the handle cover 4.

The housing 31 can include a stepped portion 322 formed under a front end of the bottom face 321. The stepped portion 322 can be formed by bending the bottom face 321 down from the front.

The shaft holder 323 can protrude from the stepped portion 322.

A stopper 47 can be disposed at a bottom edge of the handle cover 4. The stopper 47 can protrude downward from the boss 44.

The stopper 47 can be placed on the opposite side of the cover part 42 with respect to the axis (e.g., shaft 43) of rotation. For example, while the handle cover 4 closes the handle 3, the cover part 42 can be disposed above the axis (e.g., shaft 43) of rotation, and the stopper 47 can be disposed under the axis (e.g., shaft 43) of rotation.

The stopper 47 can be disposed above the stepped portion 322. The stopper 47 can be disposed in a space formed at the front of the bottom face 321 by the stepped portion 322.

The handle cover 4 is located at the opening 20, and therefore, while the handle 3 is closed as shown in FIGS. 5A and 5B, the stopper 46 can prevent the handle cover 4 from rotating further in the first direction by coming into contact with the bottom face 321 or the stepped portion 322.

The handle cover 4 can include a body 41 and a decoration 40 disposed at the front of the body 41. The body 41 can include the aforementioned cover part 42. The body 41 can include the boss 44, the recess 45, and the stopper 47.

The body 41 can be a different material than the decoration 40. The body 41 can be made of plastic. The body 41 can be an injection-molded product.

The decoration 40 can include the same material as the door cover 21. For example, the decoration 40 can be made of metal or coated with metal.

When the handle cover 4 is in closed state, the decoration 40 can be disposed in the same plane as the front face 211 and the upper portion 212 of the door cover 21.

Referring to FIG. 6, the driving system 5 can include a spring 59 that applies elastic force to the handle cover 4 in a direction in which the handle cover 4 closes the handle 3. The spring 59 can apply force to the handle cover 4 in the second direction d2 (see FIGS. 10A to 10C) opposite to the first direction d1 (see FIGS. 10A to 10C).

The spring 59 can be a torsion spring.

The spring 59 can be disposed on an outer side of the handle housing 31 in the width direction of the door 2. The spring 59 can be disposed between a lateral end of the handle cover 4 and the lateral face 218 of the door 2.

A spring housing 39 for holding the spring 59 can be provided on an outer side of the handle space 30 inside the housing 31 in the width direction of the door 2.

The spring housing 39 can be formed integrally with the housing 31.

The spring housing 39 can be disposed on an outer side of the handle cover 4 in the width direction of the door 2. The spring housing 39 can be disposed on an outer side of a side wall of the housing 31 in the width direction of the door 2.

The handle cover 4 can include a handle cover shaft 43 that provides the center of rotation of the handle cover 4. The handle cover shaft 43 can extend in the width direction of the door 2. The handle cover shaft 43 can penetrate a side wall 38 of the housing 31.

The handle cover 4 can rotate integrally with the handle cover shaft 43.

The handle cover shaft 43 can include a coupling 435 that is coupled to the holder 591. The coupling 435 can have a non-circular outer perimeter. For example, the coupling 435 can have a hexagonal column shape.

The driving system 5 can include a holder 591 to be connected to the spring 59. The holder 591 can be disposed at the spring housing 39.

The holder 591 can be coupled to the handle cover shaft 43 and rotate with the handle cover shaft 43. The holder 591 can include a coupling hole that has a shape corresponding to the coupling 435 of the handle cover shaft 43.

The holder 591 can include a slider 593 that protrudes toward the side wall 38. The slider 593 can be radially spaced apart from the handle cover shaft 43.

The spring housing 39 can include an arc-shaped guide 594 into which the slider 593 is inserted.

In some examples, the decoration 40 of the handle cover 4 can include a coupling 401 that protrudes toward the body 41. The decoration 40 can be coupled to the body 41 through the coupling 401.

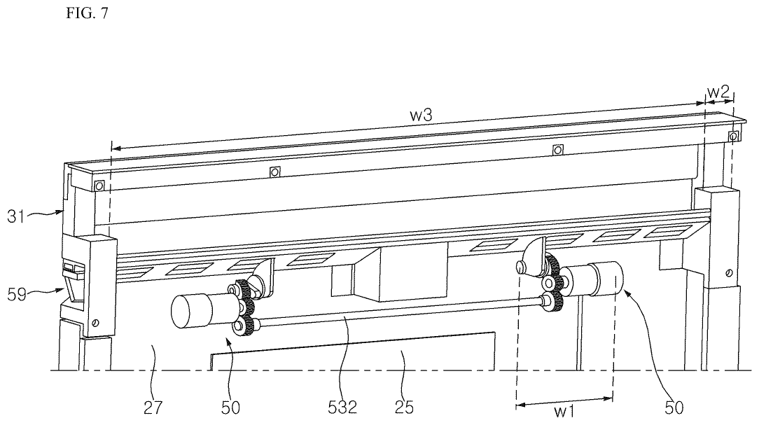

Referring to FIG. 7, the driving unit 50 can be positioned under the housing 31.

The handle 3 and the handle cover 4 can extend longer laterally than vertically. The handle 3 and the handle cover 4 can extend all the way to opposite sides of the door 2 or can extend contiguous to opposite sides of the door 2.

For example, the length w3 of the handle 3 and the cover 4 in the width direction of the door 2 can be greater than the distance w2 between the handle 3 or cover 4 and the lateral face 218 of the door 2. The distance w2 between the handle 3 or cover 4 and the lateral face 218 of the door 2 can be smaller than the width w1 of the driving unit 50.

The spring 59 can be disposed on an outer side of the housing 31 in the width direction of the door 2. The spring 59 can be disposed between the housing 31 and the lateral face 218 (see FIG. 1) of the door 2.

In some examples, a plurality of driving units 50 can be provided. The driving system 5 can include a connecting shaft 53 that connects a pinion 523 (see FIG. 8) of a motor 52 (see FIG. 8) of one of the driving units and a pinion 523 of a motor 52 of another driving unit.

The dishwasher can include a sensor 25. The sensor 25 can sense an object near the dishwasher. For example, if the user approaches the dishwasher, the sensor 25 can sense this, and the controller 14 can actuate the driving unit 50 to open the handle cover 4.

Referring to FIG. 8, the driving system 5 can further include a driving unit 50 that rotates the handle cover 4.

The driving unit 50 can include a motor 52. The motor 52 can have a motor shaft 521.

The driving unit 50 can include a pinion 523 that is coupled to the motor shaft 521 of the motor 52 and rotates integrally with the motor shaft 521.

The driving unit 50 can include an actuator 54 that rotates by the motor 52.

The actuator 54 can include a first gear part 543 which meshes with the pinion 523.

The first gear part 543 can be positioned forward of the pinion 523. The first gear part 543 can be positioned higher than the pinion 523.

The actuator 54 can include an arm 542 that extends outward of the first gear part 543 along the radius of rotation of the actuator 54. The arm 542 can rotate integrally with the gear part 543.

The actuator 54 can include a finger 541 that is connected to a connector to be described later. The finger 541 can be inserted into a recess 552 of the connector 55 to be described later.

The finger 541 can protrude from the arm 542.

The driving unit 50 can include a connector 55 that rotates by the motor 52.

The connector 55 can have a lever part 551 that abuts the actuator 54.

The lever part 551 can be disposed in the first direction d1 (see FIGS. 10A to 10C) with respect to the actuator 54. The lever part 551 can rotate with the actuator 54 when the actuator 54 rotates in the first direction d1.

The connector 55 may not be restrained by the actuator 54 when the handle cover 4 rotates in the first direction d1.

The connector 55 can have a recess 552 that extends in the second direction d2 (see FIGS. 10A to 10C) opposite to the first direction d1, from the lever part 551 with respect to the center of rotation of the actuator 54.

The connector 55 can include a body 550 having the lever part 551 and a recess 552 extending in the second direction d2 opposite to the first direction d1 from the lever part 551 with respect to the center of rotation of the actuator 54, into which the actuator 54 is inserted.

The connector 55 can cause the handle cover 4 to rotate. The connector 55 can be connected to the handle cover 4 so as to rotate when the handle cover 4 rotates.

The driving unit 50 can include a driving unit shaft 53 that provides the center of rotation of the connector 55 and the actuator 54. The driving unit shaft 53 can penetrate the connector 55 and the actuator 54.

The driving unit 50 can include a link 56 that is connected to the handle cover 4. The link 56 can be rotatably connected to the handle cover 4. The link 56 can be connected to the handle cover 4 at a position spaced apart from the center of rotation of the handle cover 4.

The link 56 can have a first connecting portion 564 to be connected to the handle cover 4 and a second connecting portion 565 to be connected to the connector 55.

The first connecting portion 564 can be connected to the handle cover 4 at a position spaced apart in a radial direction r (see FIGS. 10A to 10C) from the center of rotation of the handle cover 4.

The dishwasher can further include a bracket 57 that is coupled to the handle cover 4 and connected to the first connecting portion 564 of the link 56. The first connecting portion 564 can be rotatably coupled to the bracket 57.

The bracket 57 can be spaced apart in the radial direction r from the center (e.g., shaft 43) of rotation of the handle cover 4.

The connector 55 can be connected to the link 56. The connector 55 can include a joint 556 that extends from the body 550 and is connected to the second connecting portion 565. The second connecting portion 565 can be rotatably coupled to the joint 556.

The connector 55 can include a second gear part 558. The second gear part 558 can be disposed on an outer side of the body 550.

The driving system 5 can include a rotary damper 58 that meshes with the second gear part 558 of the connector 55.

The rotary damper 58 can be a unidirectional damper which applies force to the connector 55 in the second direction d2 opposite to the first direction d1 when the connector 55 rotates in the first direction d1.

Alternatively, the rotary damper 58 can be a bidirectional damper which applies force to the connector 55 in the first direction d1 when the connector 55 rotates in the second direction d2.

The driving unit 50 can include a driving unit housing 51. The driving unit housing 51 can include a first driving unit housing 511 and a second driving unit housing 512 which are held together.

First and second bearings 531 and 532 can be disposed in the driving unit housing 51. The first and second bearings 531 and 532 can rotatably support the driving unit shaft 53 on the driving unit housing 51.

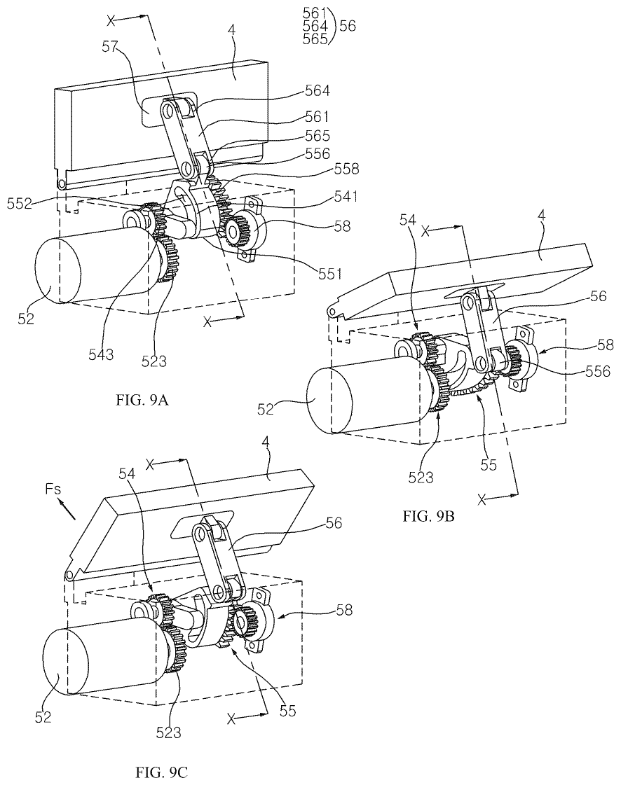

FIGS. 9A to 9C and FIGS. 10A to 10C are a schematic view and cross-sectional view showing how the driving unit 50 operates, in which FIGS. 9A and 10A depict the handle closed by the handle cover, FIGS. 9B and 10B depict the handle opened by the driving unit by rotating the handle cover, and FIGS. 9C and 10C depict that the driving unit is rotating the handle cover in a direction that closes the handle when the handle cover is open, before the handle cover closes the handle.

Referring to FIG. 9A and FIG. 10A, the handle cover 4 can close off the handle space 30 of the handle 3. The handle cover 4 can be disposed at the opening 20 and close off the handle space 30 of the handle 3.

Referring to FIG. 9B and FIG. 10B, the handle cover 4 can open up the handle space 30 of the handle 3. The handle cover 4 can rotate in the first direction d1 (see FIGS. 10A to 10C) so as to get into the handle space 30 of the handle 3. The handle cover 4 can rotate in the first direction d1 and open up the handle space 30 of the handle 3.

When the motor 52 rotates, the actuator 54 rotates since the pinion 523 is meshed with the first gear part 543 of the actuator 54.

The finger 541 of the actuator 54 applies force to the lever part 551 of the connector 55 to rotate the connector 55 in the first direction d1.

The link 56 coupled to the bracket 57 rotates the handle cover in the first direction d1, and the handle cover 4 is opened.

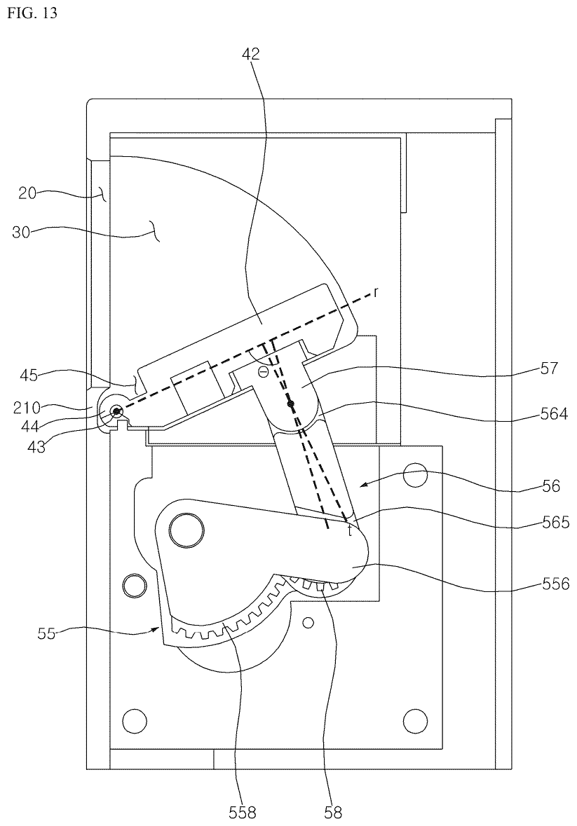

Referring to FIG. 13, the angle between the handle cover 4 and the link 56 can be smaller than 90 degrees when the handle cover 4 is open. The angle θ between the handle cover 4 and the link 56 can be smaller than 90 degrees in the process in which the handle cover 4 rotates between closed state and open state.

Referring to FIG. 9C and FIG. 10C, when the motor 52 rotates in a direction opposite to when the handle cover 4 opens, the actuator 54 rotates in the second direction d2 as the pinion 523 and the gear part 543 are meshed together.

When the actuator 54 rotates in the second direction d2, the force of the finger 541 restraining the lever part 551 is released, and the spring 59 applies force Fs to the handle cover 4 in the second direction d2. The handle cover 4 is opened by the spring 59 and rotates the connector 55 in the second direction d2 through a link.

When the connector 55 rotates in the second direction d2, the damper 58 applies force to the connector 55 in the first direction d1, the connector 55 rotates in the second direction d2 more slowly than the actuator 54, and the finger 541 and the lever part 551 are spaced apart from each other.

By the spring 59, the handle cover 4 goes back to closed state as illustrated in FIG. 9A and FIG. 10A.

If an external object, such as the user's hand or the like, stops the handle cover 4 from rotating in the second direction d2 in the process in which the handle cover 4 is closed, even if the actuator 54 rotates, the finger 541 moves within the recess 552 of the connector 55, and, as a result, the connector 55 does not rotate. Consequently, the handle cover 4 can be stopped by an external force regardless of whether the motor is running or not, in the process of being closed.

Referring to FIGS. 10A to 10C, the center (e.g., shaft 53) of rotation of the connector 55 can be vertically placed between the motor shaft 521 of the motor 52 and the center (e.g., shaft 43) of rotation of the handle cover 4. The center (e.g., shaft 53) of rotation of the connector 55 can be placed between the motor shaft 521 of the motor 52 and the center (e.g., shaft 43) of rotation of the handle cover 4 in the front-rear direction.

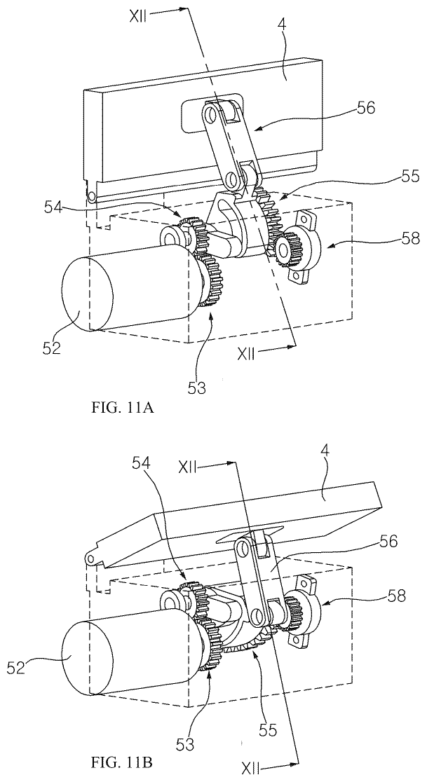

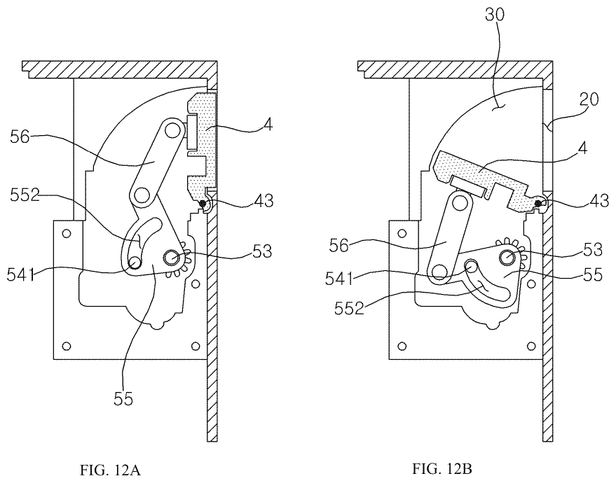

FIGS. 11A and 11B and FIGS. 12A to 12B are a schematic view and cross-sectional view showing an operation in which the handle cover opens while the driving unit is stopped, in which FIGS. 11A and 12A depict the handle closed by the handle cover, and FIGS. 11B and 12B depict that the handle cover is open while the driving unit is stopped.

Referring to FIG. 11A and FIG. 12A, the handle cover 4 can close off the handle space 30 of the handle 3. The handle cover 4 can be disposed at the opening 20 and close off the handle space 30 of the handle 3.

Referring to FIG. 11B and FIG. 12B, the handle cover 4 can open up the handle space 30 of the handle 3. The handle cover 4 can rotate in the first direction d1 (see FIGS. 10A to 10C) so as to get into the handle space 30 of the handle 3. The handle cover 4 can rotate in the first direction d1 and open up the handle space 30 of the handle 3.

While the motor 52 is stopped, the pinion 523 and the actuator 54 can remain stopped.

When an external force is applied to the handle cover 4 in the first direction d1, the handle cover 4 opens as it rotates about the central axis of the shaft 43 of rotation of the handle cover 4, and the connector 55 rotates about the driving unit shaft 53.

In this process, the position of the finger 541 relative to the recess 552 of the connector 55 is moved, and the movement of the handle cover 4 does not affect the motor 52.

When the external force applied to the handle cover 4 in the first direction d1 is released, the handle cover 4 rotates in the second direction d3 by the spring 59, and returns slowly to closed state by the damper 58 as illustrated in FIG. 11A and FIG. 12A.

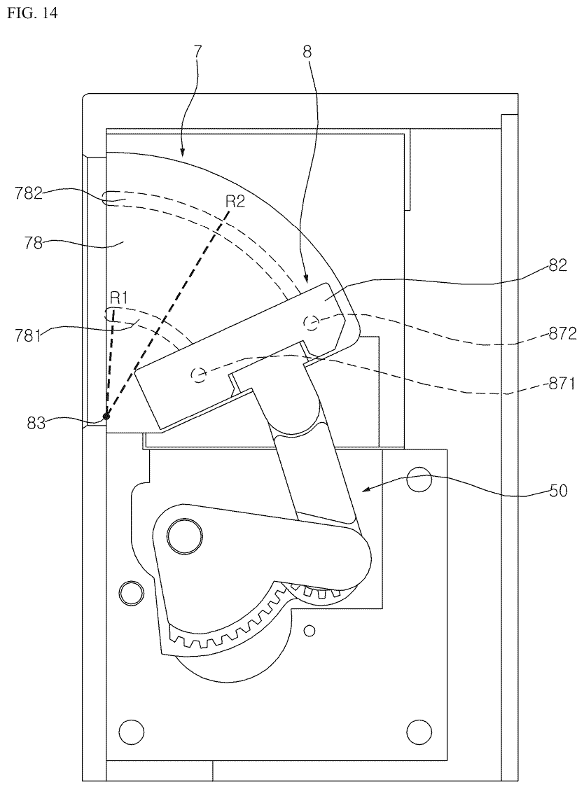

In some implementations, referring to FIG. 14, the housing 7 can include arc-shaped guides 781 and 782 on a side wall 78, and the handle cover 8 includes a cover part 82 and sliders 871 and 872 that are disposed on the cover part 82 and protrude toward the side wall 78.

The guides 781 and 782 can include a first guide 781 and a second guide 782 which have a concentric arc shape but have different radii.

The radius R1 of the first guide 781 can be smaller than the radius R2 of the second guide 782.

The first and second sliders 871 and 872 can be radially spaced by R1 and R2, respectively, from the center of rotation and be inserted into the first and second guides 781 and 782, respectively.

In some implementations, although the center of rotation of the handle cover 8 of the dishwasher is located at the opening 20 of the handle 3, the central axis of the handle cover 4 may not be exposed to the outside since the center of rotation is not a physical axis.

The other components are identical to those in the foregoing implementation, so descriptions thereof will be omitted.

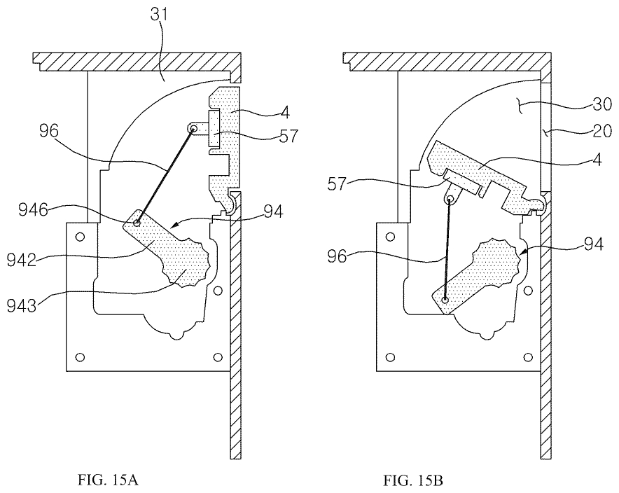

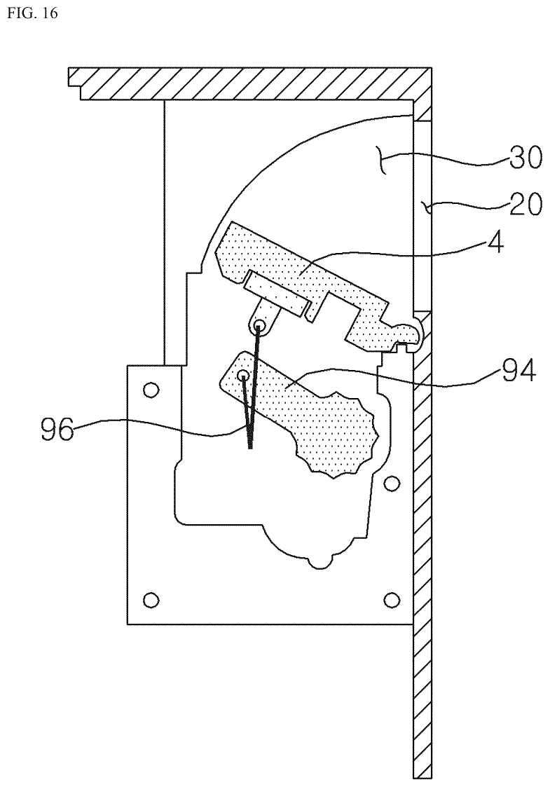

Referring to FIGS. 15A and 15B and 16, the driving unit of a dishwasher is different from the foregoing implementations in that the connector and the link are replaced with a strap 96.

The actuator 94 includes an arm 942, a gear part 943, and a connecting portion 946 connected to the strap 96.

The strap 96 is connected to the bracket 57 and the connecting portion 946 of the actuator 94.

The strap 96 is made of a flexible material that bends by gravity unless tensile force is exerted.

Referring to FIGS. 15A and 15B, the handle cover 4 can open up and close off the opening 20. When the handle cover 4 is in closed state, one end of the strap 96 can be fixed to the actuator 94 and tensile force can be exerted on the strap 96 by the elastic force of a spring exerted on the handle cover 4.

When the gear part 943 of the actuator 94 meshes with the pinion 523 and therefore the motor 52 rotates, the actuator 94 rotates, causing the handle cover 4 to rotate in the first direction d1 through the strap 96.

Referring to FIG. 16, when the motor 52 rotates in the opposite direction, the distance between the connecting portion 946 of the actuator 94 and the bracket 57 becomes smaller, and therefore the tensile force is released and the handle cover 4 is closed by the spring 59. When the spring 59 is closed, the damper 58 applies force to the handle cover 4 in the first direction and therefore the handle cover 4 can be slowly closed.

The other components are identical to those in the foregoing implementation, so descriptions thereof will be omitted.

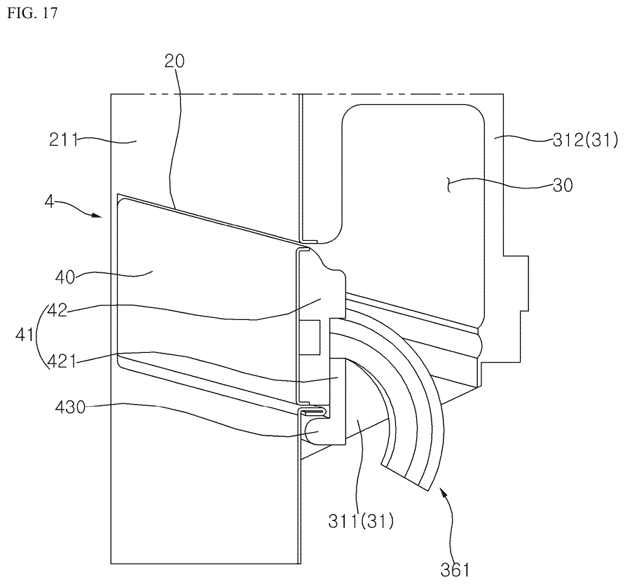

Referring to FIGS. 17 to 26, a dishwasher will be described.

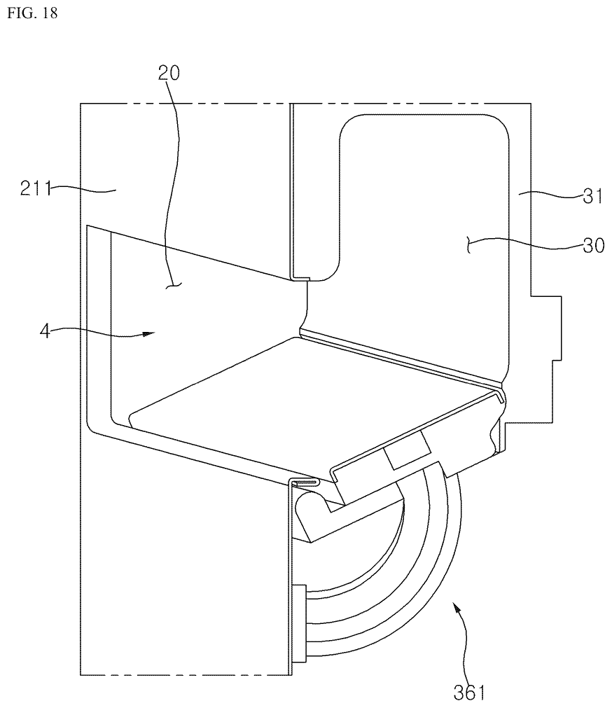

Referring to FIGS. 17 and 18, the handle cover 4 can include a body 41 by way of example. The body 41 can include a cover part 42 that corresponds in outward appearance to the opening 20 of the front face 211 of the door. Hereinafter, the cover part 42 can be referred to as a first cover body 42.

The handle cover 4 can include a second cover body 421 extending downward from the first cover body 42. The second cover body 421 can be coupled to a rear face of the first cover body 42.

The handle cover 4 can include a decoration 40 to be coupled to a front face of the first cover body 42.

The first cover body 42 forms an overall exterior of the handle cover 4 and serves to give rigidity to the handle cover 4.

The first cover body 42 can be formed in the shape of a plate that is longer in lateral width than in vertical width.

The second cover body 421 is coupled to the rear face of the first cover body 42 and serves to rotatably support the first cover body 42.

As described previously, a cover hinge 430 can be provided on the second cover body 421 so that the handle cover 4 is configured to rotate about the bottom. The cover hinge 430 can be disposed under the opening 20 of the door 2. The center of rotation of the handle cover 4 can be disposed under the opening 20 of the door 2. The cover hinge 430 can be located at the rear of the door cover 21. The center of rotation of the handle cover 4 can be located at the rear of the door cover 21.

In the handle cover 4 of the foregoing implementation, a boss 44 is formed at the bottom of the body 41, and the shaft 43 of the handle cover 4 is inserted into the boss 44. In this implementation, the cover hinge 430 can hold the shaft 43 of the handle cover 4 like the boss 44 does, or the shaft 43 of the handle cover 4 can protrude from the cover hinge 430.

As illustrated in the drawings, the cover hinge 430 can be connected to the housing 31 to rotate relative to the housing 31. Like in the foregoing implementation, the housing 31 can include a first housing 311 and a second housing 312. The first housing 311 and the second housing 312 can be separately provided and held together, or can be integrally formed.

In some examples, the cover hinge 430 can be vertically formed at a lower position than the bottom of the first cover body 42.

As such, when the second cover body 421 rotates to the foremost position, the second cover body 421 comes into contact with the housing 31, and therefore the handle cover 4 is kept from rotating further forward. Accordingly, the second cover body 421 and the cover hinge 430 can serve as a stopper that stops the handle cover 4 from rotating further forward.

A return spring (not shown) that exerts restorative force to the handle cover 4 can be connected to the cover hinge 430 so that the handle cover 4 rotates to the foremost position.

The return spring can include, but not limited to, a torsion spring, one end of which is connected to the door 2 or the housing 31, and the other end of which is connected to the cover hinge 430 of the handle cover 4.

In some examples, the driving unit 36 can include a rack gear 361 to be described later, and one end of the rack gear 361 can be connected to the second cover body 421.

Accordingly, the rack gear 461 moves together with the forward or rearward rotation of the handle cover 4.

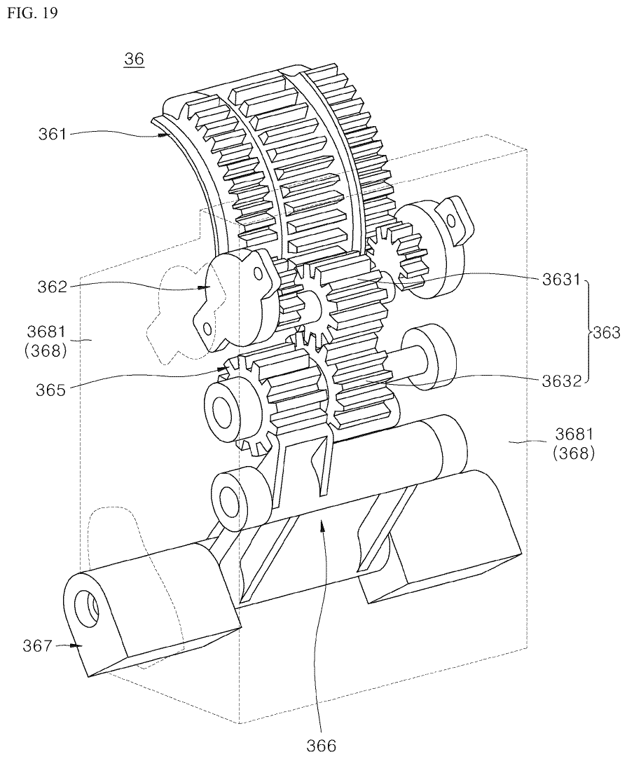

A detailed construction of the driving unit 36 including the rack gear 361 will be described with reference to FIG. 19 and the subsequent figures.

The decoration 40 is coupled to the front face of the first cover body 42 and serves to form a front face 211 of the handle cover 4.

In this case, the decoration 40 can be formed of a material having the same texture as the front face 211 of the door 2.

As such, a sense of integrity can be created between a decorative panel 315 and the front face 211 of the door 2, the outward appearance of the door 2 can be aesthetically improved, and the user can feel more aesthetic pleasure.

Moreover, as illustrated in FIG. 17, once the handle cover 4 is rotated to the foremost position, the decoration 40 can become parallel to the front face 211 so that the decoration 40 and the front face 211 of the door 2 form a continuous surface together.

That is, in some examples, no stepped portion may be formed between the front face 211 of the door 2 and the front surface of the handle 3.

As such, once the handle cover 4 is rotated to the foremost position, the opening 20 at the front face 211 is fully closed off, and, at the same time, no stepped portion may be formed between the front face 211 and the decoration 40, thereby preventing the build-up of impurities such as dust in a recessed portion of the door 2 or on the handle itself.

In some examples, as described previously, the handle cover 4 can be configured to automatically return from the rearmost position illustrated in FIG. 18 toward the foremost position by the restorative force of a return spring connected to the cover hinge 430.

In some cases, when the handle cover 4 returns to the foremost position while the user's fingers are in the handle space 30 inside the housing 31, the user's fingers can get caught and stuck between the opening 20 of the front face 211 and the top of the handle cover 4.

In some implementations, to prevent the user from being injured by getting their fingers caught, a driving unit 36 can be further included to restrict a forward rotation of the handle cover 4 by operating in conjunction with an angle of rotation of the door 2 created when the door 2 is opened or closed.

For example, the driving unit 36 can restrain the handle cover 4 from rotating by the return spring to change the state of the opening 20 from open to closed, or can allow the handle cover 4 to rotate In some examples.

In this case, the forward rotation of the handle cover 4 can be allowed or prevented according to the angle of rotation of the door 2.

The door 2 of a dishwasher can open up the tub 1 as it rotates forward around a hinge portion as the axis of rotation, as described previously.

In some implementations, the door 2 can be rotatably disposed between a closed position in which the open front face of the tub 1 is closed and a fully open position in which the open front face of the tub 1 is fully open.

As will be described below, the position of the door 2 based on which the forward rotation of the handle cover 4 is allowed or prevented can be a cover release position which is defined between the closed position and the fully open position.

When the user rotates the door 2 less than the angle of rotation corresponding to the cover release position, the driving unit 36 can prevent the handle cover 4 from rotating to the foremost position, and when the user rotates the door 2 by the angle of rotation corresponding to the cover release position, the driving unit 36 can allow the handle cover 4 to rotate to the foremost position.

In some examples, the cover release position can be expected to be a position where it is highly likely the user will pull out their hand from the handle 3 after the door 2 starts opening. More specifically, the angle of rotation of the door 2 corresponding to the cover release position can range from 45 to 55 degrees, e.g., 50 degrees.

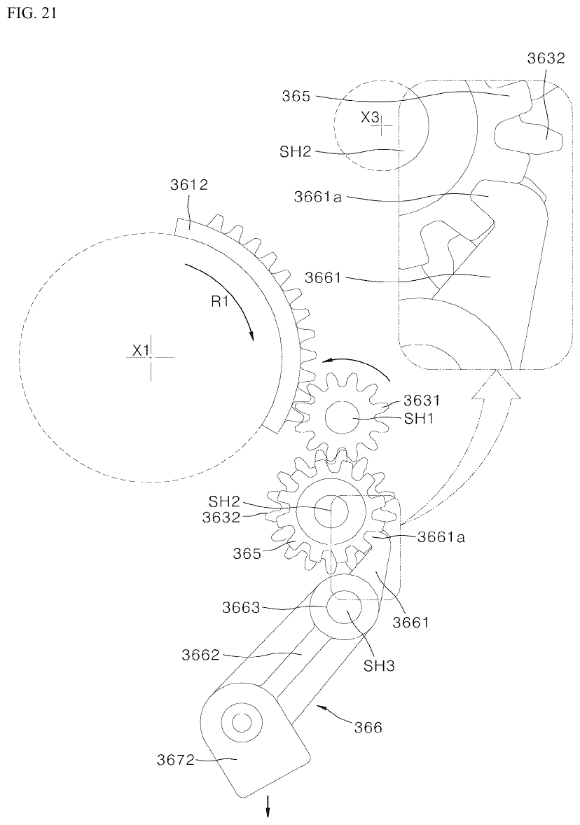

A detailed description of how the forward rotation of the handle cover 4 is allowed or prevented in conjunction with the angular range of rotation will be given below with reference to FIG. 21 and the subsequent drawings.

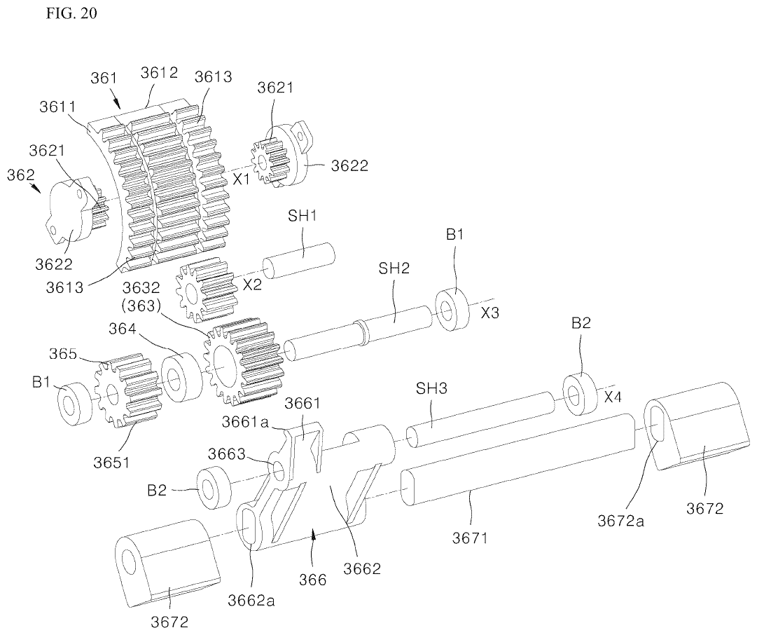

Hereinafter, referring to FIG. 19 and FIG. 20, a detailed construction of the driving unit 36 configured to allow or prevent the forward rotation of the handle cover 4 will be described.

Referring to FIG. 19 and FIG. 20, by way of example, the driving unit 36 can include a driving unit housing 368 having a predetermined receiving space inside, a rack gear 361 whose one end of which is connected to the handle cover 4, that rotates with the handle cover 4, a rotary damper 362 connected to the rack gear 361, for reducing the rotational speeds of the rack gear 361 and the handle cover 4, a pinion gear 363 that rotates by a torque transmitted from the rack gear 361, a one-way clutch 364 with an outer wheel connected to the pinion gear 363, a ratchet gear 365 connected to an inner wheel of the one-way clutch 364, a latch link 366 having a latch portion 3661a that engages gear teeth of the ratchet gear 365, and a weight balance 367 forming the center of mass of the latch link 366.

The driving unit housing 368 constitutes the exterior of the driving unit 36 and serves to internally hold and protect the components of the driving unit 36 to be described later.

For ease of assembly, the driving unit housing 368 can include a first driving unit housing 3681 and a second driving unit housing 3682 which form separate units that are separated in a lateral direction.

A predetermined receiving space can be formed between the first driving unit housing 3681 and the second driving unit housing 3682.

The driving unit housing 368 can be disposed under the handle cover 4 inside the door 2, in order to facilitate the function of allowing or preventing the forward rotation of the handle cover 4.

In some examples, the rack gear 361 serves to transmit pressure from the user or the restorative force of the return spring to the pinion gear 363 to be described later, while rotating with the handle cover 4.

A rack body 3611 of the handle cover 4 can be connected to the handle cover 4 so as to rotate with the handle cover 4.

More specifically, a front end of the rack body 3611 which is one end can be integrally connected to the second cover body 421 based on what is illustrated in the drawings.

Moreover, the rack body 3611 can be configured to have a cylindrical shape having an arc-shaped cross section, so as to move in conjunction with the rotation of the handle cover 4 and minimize the range of movement of the rack gear 361.

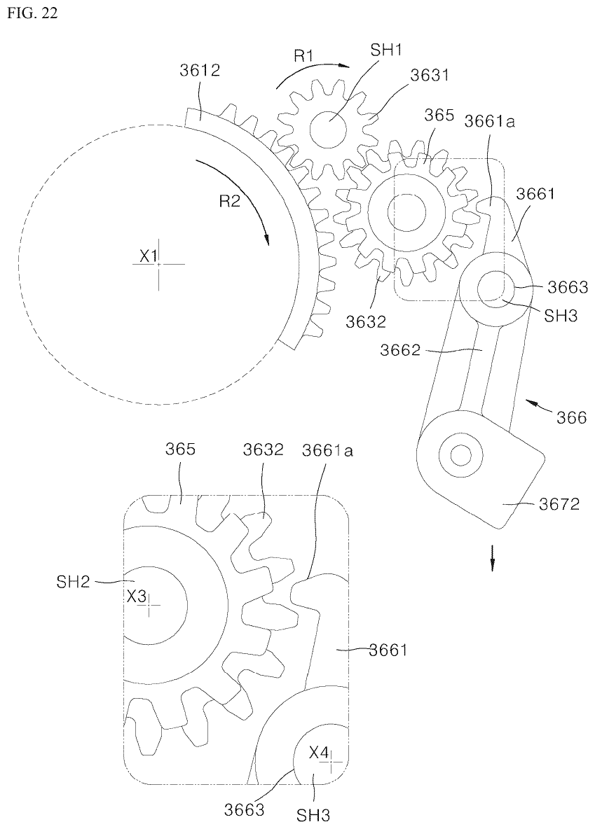

In this case, the center of the arc shape of the rack body 3611 can lie at the axis of rotation of the cover hinge 430 of the handle cover 4, as illustrated in FIG. 21 and FIG. 22.

Hereinafter, the axis of rotation of the rack body 3611 and the axis of rotation of the handle cover 4 can be referred to as a first rotational axis X1, to make them distinguishable from the axes of rotation to be described later.

As such, since the rack body 3611 has a cylindrical shape in which it is configured to rotate about the first rotational axis X1 which is concentric with the axis of rotation of the handle cover 4, the rack body 3611 can be configured to rotate about the first rotational axis X1 by the rotation of the handle cover 4.

Accordingly, it is possible to minimize the range of movement of the rack body 3611 and prevent an increase in the overall size of the driving unit 36.

In some examples, as described previously, the rack body 3611 rotates with the handle cover 4 in conjunction with the forward and rearward rotations of the handle cover 4.

Hereinafter, the direction of rotation of the rack body 3611 for the rearward movement of the handle cover 4 can be defined as a first rotational direction R1, and the direction of rotation of the rack body 3611 for the forward movement of the handle cover 4 can be defined as a second rotational direction R2.

As illustrated in the drawings, a first gear portion 3612 and a second gear portion 3613 can be integrally formed on an outer periphery of the rack body 3611.

The first gear portion 3612 can engage a first pinion gear 3631 to be described later.

Thus, the rack body 3611 can rotate with the first pinion gear 3631 by the first gear portion 3612, or can be prevented from rotating with the first pinion gear 3631.

The second gear portion 3613 can engage a damper gear 3621 of the rotary damper 362.

As illustrated in the drawings, since the second gear portion 3613 can remain constantly in engagement with the damper gear 3621 of the rotary damper 362, the speed of rotation of the rack body 3611 in both the first rotational direction R1 and the second rotational direction R2 can be reduced by the damping unit 3622 of the rotary damper 362.

Accordingly, the rotation of the rack body 3611 and the rotational movement of the handle cover 4 can be performed smoothly, thereby decreasing the likelihood of the user's fingers getting pinched or hit when the handle cover 4 rotates forward.

FIG. 19 and FIG. 20 illustrate by way of example a construction in which the first gear portion 3612 is disposed midway on the outer periphery of the rack body 3611 and a pair of second gear portions 3613 are disposed on either side of the first gear portion 3612. However, the present disclosure is not limited to this, and the arrangement and shapes of the first gear portion 3612 and the second gear portion 3613 can vary with the size and shape of the handle cover 4, the arrangement position of the driving unit 36, and so on.

In some examples, the pinion gear 363 engages the first gear portion 3612 of the rack gear 361 and serves to rotate with the rack gear 361 or prevents the rotation of the rack gear 361.

FIG. 19 and the subsequent drawings illustrate by way of example an implementation in which a first pinion gear 3631 directly engaged to the first gear portion 3612 of the rack gear 361 and a second pinion gear 3632 engaged to the first pinion gear 3631 are included. Although the present disclosure is not limited to this, the following description will be given with respect to a construction including the first pinion gear 3631 and the second pinion gear 3632.

The first pinion gear 3631 rotates in a direction opposite to the direction of rotation of the rack gear 361 by engaging the first gear portion 3612 of the rack gear 361, and serves to simply transmit the torque of the first gear portion 3612 of the rack gear 361 to the second pinion gear 3632.

Thus, when the rack gear 361 rotates in the first rotational direction R1, the first pinion gear 3631 rotates in the second rotational direction R2, and when the rack gear 361 rotates in the second rotational direction R2, the first pinion gear 3631 rotates in the second rotational direction R2.

The first pinion gear 3631, which is in idle state since it serves to simply transmit torque, can be supported on a first shaft SH1 forming the second rotational axis X2 in such a way as to rotate relative to the first shaft SH1.

The second pinion gear 3632 can engage the first pinion gear 3631 and serve to reduce the torque transmitted from the first pinion gear 3631.

Accordingly, the second pinion gear 3632 can have more gear teeth arranged along the outer periphery compared to the first pinion gear 3631.

The second pinion gear 3632 can be rotatably supported on a second shaft SH2 forming a third rotational axis X3.

It is to be noted that the second pinion gear 3632 can be connected to the second shaft SH2 through the one-way clutch 364. By way of example, the second pinion gear 3632 can be connected to the outer wheel of the one-way clutch 364.

That is, when the second pinion gear 3632 rotates in the first rotational direction R1, it can rotate relative to the second shaft SH2 connected to the inner wheel of the one-way clutch 364 by the one-way clutch 364, whereas, when the second pinion gear 3632 rotates in the second rotational direction R2, it can be supported on the second shaft SH2 in such a manner as not to rotate relative to the second shaft SH2.

In this way, by the one-way clutch 364, only the torque for the second rotational direction R2 can be transmitted to the ratchet gear 365 to be described later through the second shaft SH2.

Accordingly, as will be described later, while the ratchet gear 365 is restrained by the latch portion 3661a of the latch link 366 so as to prevent the rotation for the second rotational direction R2, the second shaft SH2 and the second pinion gear 3632 may not be able to rotate in the second rotational direction R2.

Consequently, the rotation of the rack gear 361 in the second rotational direction R2 can be prevented, and the forward rotation of the handle cover 4 can be prevented.

It is to be noted that, as will be described later, the second shaft SH2 and the second pinion gear 3632 can rotate in the second rotational direction R2 while the ratchet gear 365 is released.

As such, the rotation of the rack gear 361 in the second rotational direction R2 can be allowed, and the forward rotation of the handle cover 4 can be allowed. Thus, the handle cover 4 can rotate forward toward the foremost position by the restorative force of the return spring.

In this way, the second shaft SH2 can be connected to the ratchet gear 365 and the inner wheel of the one-way clutch 364 and supported in such a way as to rotate with them. Accordingly, opposite ends of the second shaft SH2 can be connected to the driving unit housing 368 through a first bearing B1.

The ratchet gear 365 can be connected to the aforementioned second shaft SH2 and serve to allow or prevent the rotation of the second shaft SH2 in the second rotational direction R2 by the action of the latch link 366 to be described later.

Accordingly, the ratchet gear 365 needs to rotate integrally with the second shaft SH2, and, in some examples, the second shaft SH2 can penetrate through an axial hole formed at the center of the ratchet gear 365 and be coupled in such a manner as not to perform relative rotation.

A plurality of asymmetrical gear teeth 3651 can be provided on the outer periphery of the ratchet gear 365 as will be described later.

As opposed to the first pinion gear 3631 and second pinion gear 3632, the ratchet gear 365 is not intended to transmit torque, and serves to allow or prevent the rotation of the second shaft SH2 in the second rotational direction R2 depending on whether or not the ratchet gear 365 engages the latch portion 3661a of the latch link 366 to be described later.

Accordingly, the gear teeth 3651 of the ratchet gear 365 can be configured to have a predetermined asymmetrical shape so as to easily engage and disengage the latch link 366.

In some examples, the latch link 366 can prevent the rotation of the ratchet gear 365 in the second rotational direction R2 by engaging the ratchet gear 365 as it pivots by gravity in conjunction with the angle of rotation of the door 2, or can allow the rotation of the ratchet gear 365 in the second rotational direction R2 by disengaging the ratchet gear 365.

By way of example, as illustrated in the drawings, the latch link 366 can be a bar-type link that extends in a bar shape from a first end toward a second end.

More specifically, the latch link 366 can include a first link body 3661 that extends approximately linearly from a shaft hole 3663 to be described later toward the first end and a second link body 3662 that extends approximately linearly from the shaft hole 3663 toward the second end.

In this case, as will be described later, the first link body 3661 and the second link body 3662 can extend in opposite directions to each other with respect to the shaft hole 3663, so as to easily engage and disengage the ratchet gear 365 as they pivot by the action of gravity.

In some examples, the latch portion 3661a can be disposed at the first end of the first link body 3661 to engage the above-mentioned gear teeth 3651 of the ratchet gear 365.

The latch portion 3661a can be provided in the form of a hook, for example, so as to easily engage and disengage the gear teeth 3651 of the ratchet gear 365 as the latch link 366 pivots.

It should be noted that, as will be described later, the latch portion 3661a can be configured to have surface contact with the gear teeth 3651 of the ratchet gear 365 so as to maximally prevent the ratchet gear 365 from rotating in the second rotational direction R2 while the ratchet gear 365 is engaged.

A weight balance hole 3662a into which a first weight 3671 of the weight balance 367 to be described later is inserted and coupled can be formed at the second end of the second link body 3662.

As illustrated in the drawings, the weight balance hole 3662a can be formed to have a non-circular cross-section corresponding in outward appearance to the first weight 3671.

In some examples, as described previously, the latch link 366 serves to allow or prevent the rotation of the ratchet gear 365 in the second directional direction R2 as it pivots by gravity in conjunction with the angle of rotation of the door 2.

To create as much torque as possible by gravity, the linear distance from the shaft hole 3663 as the center of rotation to the weight balance hole 3662a to which the weight balance 367 is coupled can be set to be much larger than the linear distance from the shaft hole 3663 to the latch portion 3661a.

That is, the extension length of the second link body 3662 can be much greater than the extension length of the first link body 3661.

In some examples, a third shaft SH3 pivotally supporting the latch link 366 can be coupled between the first and second ends of the latch link 366.

A shaft hole 3663 through which the third shaft SH3 penetrates and extends can be provided between the first end and the second end so that the third shaft SH3 is inserted and coupled therein.

The latch link 366 can be supported in such a way as to pivot around a fourth rotational axis X4 formed on the third shaft SH3.

In some examples, the latch link 366 needs to be supported so as to easily pivot by gravitational force acting on the weight balance 367. In some examples, both ends of the third shaft SH3 can be connected to the driving unit housing 368 through the second bearings B2.

In some examples, the weight balance 367 can be coupled to the second end of the latch link 366 opposite the latch portion 3661a with respect to the aforementioned fourth rotational axis and serve to move the center of mass of the entire latch link 366 to the weight balance 367.

More specifically, the center of mass of the entire latch link 366 can be formed at the weight balance 367 while the weight balance 367 and the latch link 366 are held together by the weight balance 367.

Accordingly, the weight balance 367 can serve as a weight that generates torque for the latch portion 3661a so as to keep the latch portion 3661a and the gear teeth 3651 of the ratchet gear 365 engaged according to the angular range of rotation of the door 2, or that brings the latch portion 3661a to a stop so as to keep the latch portion 3661a and the gear teeth 3651 of the ratchet gear 365 disengaged.

FIGS. 19 and 20 illustrate by way of example a construction in which the weight balance 367 includes a first weight 3671 to be inserted and coupled into the aforementioned weight balance hole 3662a of the latch link 366 and a pair of second weights 3672 to be respectively coupled to opposite ends of the first weight 3671.

Although the present disclosure is not limited to this, a description will be given with respect to an implementation in which the weight balance 367 includes one first weight 3671 and a pair of second weights 3672.

As illustrated in the drawings, the first weight 3671 can be configured to have a thin shape that extends longer laterally than vertically.

The first weight 3671 can be coupled to the latch link 366 in such a way as to be inserted and penetrated into the aforementioned weight balance hole 3662a.

Moreover, opposite ends of the first weight 3671 can be coupled to the second weight 3672 in such a way as to be inserted into an insertion hole 3672a formed at the second weight 3672.

In some examples, the lateral length of the first weight 3671 can be greater than the lateral length of the weight balance hole 3662a of the latch link 366.

In some examples, as illustrated in the drawings, the first weight 3671 can have a non-circular cross-section. Since the first weight 3671 has a non-circular cross-section, the first weight 3671 and the second weight 3672 can be prevented from rotating relative to the latch link 366 about the weight balance hole 3662a.

That is, once the first weight 3671 and the second weight 3672 are connected in such a way as to rotate relative to the latch link 366 about the weight balance hole 3662a, the relative position of the center of mass of the weight 367 may change with the pivotal position of the latch link 366, and the latch portion 3661a and the gear teeth 3651 of the ratchet gear 365 can be disengaged from each other according to the change in the position of the center of mass before the door 2 reaches the cover release position.

In some examples, by keeping the relative position of the center of mass of the weight balance 367 constant regardless of the pivotal position of the latch link 366, it is possible to prevent the latch portion 3661a and the gear teeth 3651 of the ratchet gear 365 from disengaging from each other before the door 2 reaches the cover release position.

In some examples, the second weight 3672 to be coupled to opposite ends of the first weight 3671 can be provided in the shape of a block that is smaller in lateral width than the first weight 3671 and larger in front-rear width and vertical width.

Accordingly, the total weight of the pair of second weights 3672 can be greater than the first weight 3671.

Moreover, the pair of second weights 3672 can be placed symmetrically with respect to the first weight 3671.

As such, the combined center of mass of the weight balance 367 and the latch link 366 can be formed inside the pair of second weights 3672.

Hereinafter, referring to FIGS. 21 to 24, a description will be given of how the rotation of the ratchet gear 365 in conjunction with the angle of rotation of the door 2 is restrained and released.

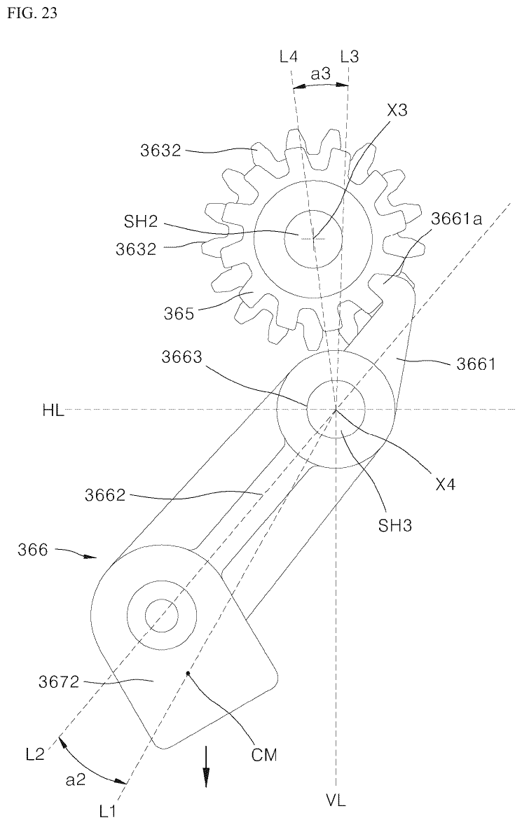

FIG. 21 and FIG. 23 illustrate that the ratchet gear 35 is restrained by the latch link 366 so as to prevent rotation in the second rotational direction R2 while the door 2 is closed and the handle space 30 is closed by the handle cover 4.

Referring to FIG. 21, if the user pushes the handle cover 4 in order to open the door 2 while the door 2 is closed and the handle space 30 is closed by the handle cover 4, the handle cover 4 can start moving rearward.

As the handle cover 4 moves rearward, the rack gear 361 connected to the handle cover 4 rotates in the first rotational direction R1 along the first rotational axis X1.

When the rack gear 361 rotates in the first rotational direction R1, the first pinion gear 3631 engaging the first gear portion 3612 of the rack gear 361 rotates in the second rotational direction R2.

Also, when the first pinion gear 3631 rotates in the second rotational direction R2, the second pinion gear 3632 engaging the first pinion gear 3631 can rotate in the first rotational direction R1.

In this case, although the second pinion gear 3632 rotates with the rotation of the first pinion gear 3631, the one-way clutch 364 prevents the rotation of the second pinion gear 3632 from being transmitted to the second shaft SH2.

This is because, as described previously, the one-way clutch 364 is configured to not transmit the torque for the first rotational direction R1 to the second shaft SH2.

Accordingly, the torque is not transmitted to the second shaft SH2 and the ratchet gear 365, and they can be kept in stopped state.

Once the pressure from the user is released after continuing rearward movement of the handle cover 4, the rack gear 361 can rotate as much as a corresponding angle and then stop. That is, the rack gear 361 can be configured to stop at a middle position even if the handle cover 4 is not rotated to the rearmost position.

In this case, after the rack gear 361 is stopped, a restorative force for the second rotational direction R2 can be applied to the handle cover 4 and the rack gear 361 by a return spring that acts upon the cover hinge 430 of the handle cover 4.

However, since the ratchet gear 365 is restrained by engaging the latch portion 3661a of the latch link 366, as illustrated in FIG. 21, the rotation of the ratchet gear 365 in the second rotational direction R2 is prevented.

Accordingly, the second shaft SH2, the second pinion gear 3632, the first pinion gear 3631, and the rack gear 361 can be prevented from rotating in the second rotational direction R2, and the handle cover 4 can be currently kept in stopped position.

FIG. 23 illustrates as described above that the ratchet gear 365 is prevented and restrained from rotating in the second rotational direction R2 by engaging the latch portion 3661a of the latch link 366.

As illustrated in FIG. 23, once the latch portion 3661a of the latch link 366 engages the ratchet gear 365 while the door 2 is closed, the center of mass CM of the weight balance 367 can be rotated forward by a predetermined angle.

More specifically, a first intersecting angle a1 can be formed between a vertical line VL passing through the fourth rotational axis X4 and a virtual first extended line L1 passing through the fourth rotational axis X4 and the center of mass CM of the weight balance 367.

In this way, by forming a first intersecting angle a1 between a vertical line VL passing through the fourth rotational axis X4 and a virtual first extended line L1 passing through the fourth rotational axis X4 and the center of mass CM of the weight balance 367, a rotational force or torque can be created by a gravitational force acting on the center of mass CM so that the latch link 366 rotates counterclockwise about the fourth rotational axis X4.

By the rotational force or torque created by the gravitational force, an action force that pushes the gear teeth 3651 of the ratchet gear 365 can be generated at the latch portion 3661a placed opposite with respect to the fourth rotational axis X4.

By this action force of the latch portion 3661a, the ratchet gear 365 can continuously remain prevented and restrained from rotating in the second rotational direction R2.

In this case, the first intersecting angle a1 can be set equal to the angle of rotation of the door 2 corresponding to the above-described cover release position.

Accordingly, the first intersecting angle a1 can range from 45 to 55 degrees, e.g., 50 degrees.

In some examples, as illustrated in the drawings, a predetermined second intersecting angle a2 can be formed between the virtual first extended line L1 and a virtual second extended line L2 passing through the fourth rotational axis X4 and parallel to the extension direction of the second link body 3662 of the latch link 366.

That is, the center of mass CM of the weight balance 367 can be formed at a position displaced toward the rear by the second intersecting angle a2 with respect to the extension direction of the second link body 3662 of the latch link 366.

In some examples, as illustrated in FIG. 23, while the latch portion 3661a of the latch link 366 engages the ratchet gear 365, a predetermined third intersecting angle a3 can be formed between a virtual third extended line L3 passing through the fourth rotational axis X4 and a front end portion of the latch portion 3661a and a virtual fourth extended line L4 passing through the third rotational axis X3 as the center of rotation of the ratchet gear 365 and the fourth rotational axis X4.

As illustrated in the drawings, the third intersecting angle a3 can be smaller than the first intersecting angle a1 and the angle of rotation of the door 2 corresponding to the cover release position.

Accordingly, as will be described later, when the door 2 is rotated until the angle of rotation corresponding to the cover release position is reached, the third intersecting angle a3 increases gradually, thereby allowing the latch portion 3661a of the latch link 366 and the gear teeth of the ratchet gear 365 to easily disengage from each other.

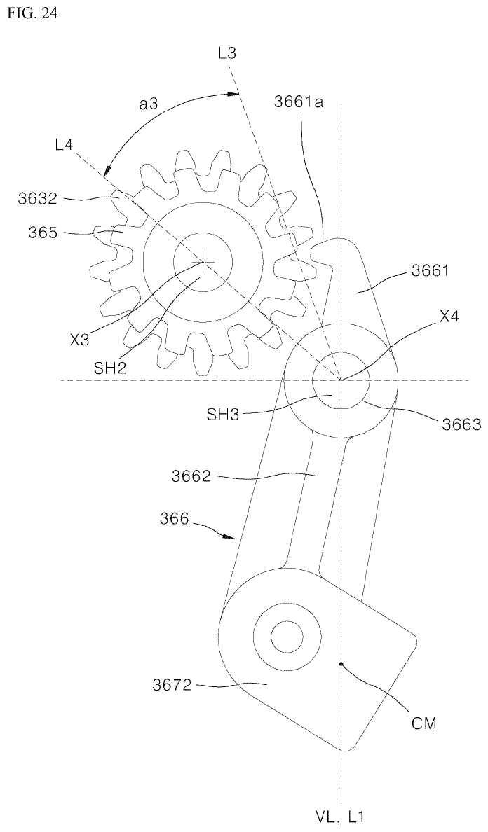

FIGS. 22 and 24 illustrate that the door 2 is opened and rotated by an angle of rotation corresponding to the cover release position, and that the ratchet gear 365 is released by the latch link 366 so as to rotate in the second rotational direction R2.

Referring to FIG. 22 and FIG. 24, when the angle of rotation of the door 2 reaches the angle of rotation corresponding to the cover release position after the door 2 starts opening, the ratchet gear 365 and the latch portion 3661a of the latch link 366 can be disengaged from each other.

More specifically, as the angle of rotation of the door 2 increases, the intersecting angle formed between the virtual fourth extended line L4 and the vertical line VL increases gradually, but the aforementioned first intersecting angle a1 becomes gradually smaller.

Afterwards, when the door 2 continues to be open and the angle of rotation of the door 2 reaches the angle of rotation corresponding to the cover release position, as illustrated in FIG. 24, the intersecting angle formed between the vertical line VL passing through the fourth rotational axis X4 and the aforementioned fourth extended line L4 can be larger than the angle of rotation corresponding to the cover release position.

In this case, when the angle of rotation of the door 2 reaches the angle of rotation corresponding to the cover release position, the first intersecting angle a1 can be 0 degree, and the virtual first extended line L1 can be vertically aligned.

This is because, as described previously, the first intersecting angle a1 and the angle of rotation corresponding to the cover release position are set equal.

Thus, the virtual first extended line L1 can be kept vertically aligned by the gravitational force acting on the center of mass CM of the weight balance 367, even if the angle of rotation of the door 2 exceeds the angle of rotation corresponding to the cover release position.

Accordingly, the position of the latch link 366 is kept constant regardless of the angle of rotation of the door 2, and the intersecting angle formed between the vertical line VL passing through the fourth rotational axis X4 and the above-described virtual fourth extended line L4 increases gradually, whereby the distance between the ratchet gear 365 and the latch portion 3661a increases gradually, and therefore the ratchet gear 365 and the latch portion 3661a can be automatically disengaged from each other.

In some examples, once the ratchet gear 365 and the latch portion 3661a are disengaged from each other, the ratchet gear 365 and the third shaft SH3 can be released from the restrained state for the second rotational direction R2.

Accordingly, the second pinion gear 3632, the first pinion gear 3631, and the rack gear 361 connected to the third shaft SH3 through the one-way clutch 364 can be released from the restrained state for the second rotational direction R2, and, as described previously, the handle cover 4 and the rack gear 361 can start rotating in the second rotational direction R2 as illustrated in FIG. 22 by the restorative force of the return spring connected to the cover hinge 430 of the handle cover 4.

As such, after starting rotating in the second rotational direction R2, the handle cover 4 can reach the aforementioned foremost position and then stop, and the opening 20 of the front face 211 of the door 2 can be closed off again.

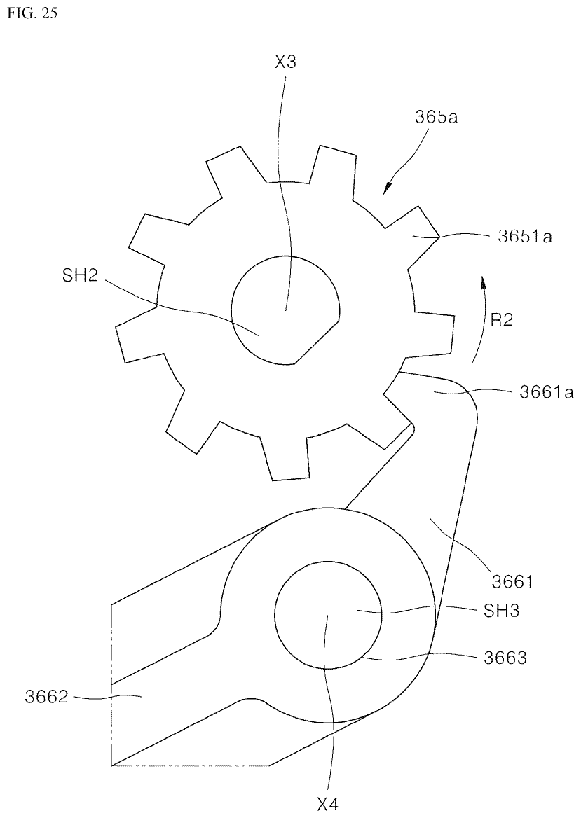

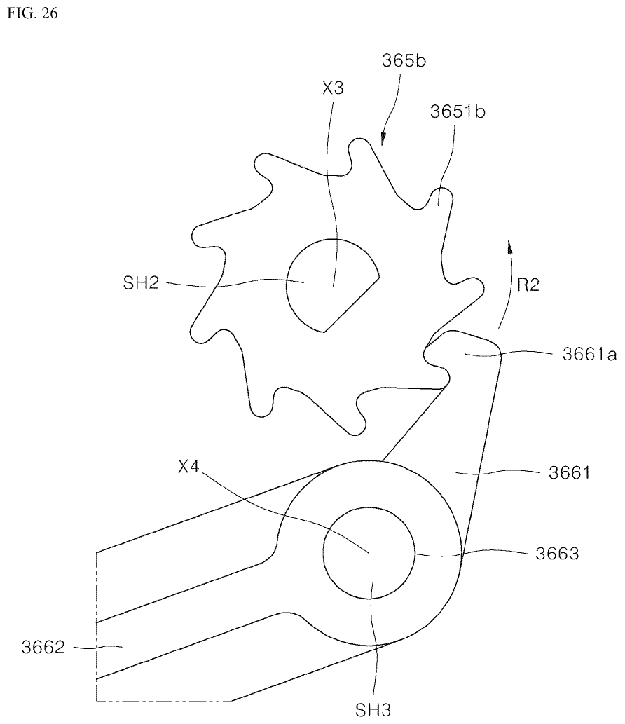

Hereinafter, referring to FIG. 25 and FIG. 26, examples of the shape of the gear teeth 3651 of the ratchet gear 365 according to the present disclosure will be described.

As described previously, the gear teeth of the ratchet gear can be configured to have a predetermined asymmetrical shape so as to easily engage and disengage the latch link 366.

More specifically, each of the gear teeth of the ratchet gear can be formed to have an asymmetrical shape with respect to the radius of the ratchet gear.

FIG. 25 illustrates an example of the gear teeth of the ratchet gear.

As illustrated in FIG. 25, the gear teeth 3651a of the ratchet gear 365a can be formed in such a way that one side making direct contact with the latch portion 3661a of the latch link 366 and the other side facing the one side extend in different directions, so as to have an asymmetrical shape with respect to the radius.

In this case, the one side can extend radially, as illustrated in the drawings, and the other side can extend at a slant toward the second rotational direction R2.

As such, the rotation in the second rotational direction R2 can be maximally prevented by defining the extension direction of one side and the extension direction of the other side.

In some examples, the ratchet gear 365a can be configured in such a way that the circumferential width of each individual gear tooth 3651a stays approximately constant along the radius.

Moreover, the circumferential width of each individual gear tooth 3651a which stays constant can be larger than the circumferential width of the latch portion 3661a.

Hence, each individual gear tooth 3651a of the ratchet gear 365a can have high rigidity.

However, this large circumferential width of each individual gear tooth 3651 can narrow the space between adjacent gear teeth. Even then, the circumferential width of the latch portion 3661a can be made correspondingly smaller, thereby allowing the latch portion 3661a to easily disengage and re-engage.

In some examples, FIG. 26 illustrates the gear teeth of the ratchet gear according to a second implementation.

As illustrated in FIG. 26, the gear teeth 3651b of the ratchet gear 365b according to another implementation can be formed in such a way that one side making direct contact with the latch portion 3661a of the latch link 366 and the other side facing the one side extend in the same direction, so as to have an asymmetrical shape with respect to the radius.

In this case, the one side and the other side can extend at a slant toward the second rotational direction R2.

As such, the rotation in the second rotational direction R2 can be maximally prevented by defining the same extension direction for both one side and the other side.

In some examples, the ratchet gear 365a according to the second implementation can be configured in such a way that the circumferential width of each individual gear tooth 3651b decreases gradually along the radius.

Moreover, as illustrated in the drawings, the circumferential width of each individual gear tooth 3651b can be smaller than the circumferential width of the latch portion 3661a.

Hence, each individual gear tooth 3651b of the ratchet gear 365a can have relatively low rigidity, but the space between adjacent gear teeth can be relatively large, thereby allowing the latch portion 3661a to easily disengage and re-engage.

In some implementations, the dishwasher includes components for rotating the handle cover that are efficiently arranged in a narrow space inside the door. In some implementations, the dishwasher includes the handle and the handle cover that extend longer in a width direction of the door than a height direction. In some implementations, the dishwasher ensures that the handle cover opens at a large angle. In some implementations, the dishwasher helps prevent the user's fingers from getting caught in a handle cover that automatically opens and closes. In some implementations, the dishwasher with a handle cover automatically opens and closes and also can be manually opened and closed by the user.

In some implementations, the dishwasher allows the motion of the handle cover that is not restrained by the motor when the user manually opens or closes the handle cover. In some implementations, the dishwasher opens and closes by elasticity. In some implementations, the dishwasher opens fast when the handle cover is opened and closes slowly when the handle cover is closed. In some implementations, there is provided a dishwasher that provides better aesthetic outward appearance.

Any or other implementations of the present disclosure described above are not mutually exclusive or distinct. Any or other implementations of the present disclosure described above can be used jointly or combined in each configuration or function.

The above detailed description should not be construed as restrictive in all respects and should be considered as illustrative. The scope of the present disclosure should be determined by a reasonable interpretation of the appended claims, and all modifications within the equivalent scope of the present disclosure are included in the scope of the present disclosure.

What is claimed is:

1. A dishwasher comprising:
a tub that defines a washing chamber, the washing chamber being opened to a front side of the tub;
a door configured to open and close the washing chamber, the door comprising a front face having an opening;
a handle that is disposed at the door and defines a handle space connected to the opening of the door, the handle space being defined rearward relative to the opening of the door; and
a handle cover disposed at the opening of the door and configured to open and close the handle space based on rotating about a center of rotation relative to the front face of the door, the handle cover comprising an upper portion configured to move into the handle space based on the handle cover opening the handle space,
wherein the center of rotation of the handle cover is disposed below the opening of the door.

2. The dishwasher of claim 1, wherein the door further comprises a door cover that defines the front face of the door, and
wherein the center of rotation of the handle cover is disposed rearward relative to the door cover.

3. The dishwasher of claim 2, wherein the door cover comprises a rim that defines a lower edge of the opening of the door and that is disposed above the center of rotation of the handle cover.

4. The dishwasher of claim 3, wherein the handle cover comprises:
a cover part configured to open and close the opening of the door;
a shaft that defines the center of rotation of the handle cover; and
a boss that accommodates the shaft, and
wherein the rim is disposed vertically above the boss and covers at least a part of the boss.

5. The dishwasher of claim 4, wherein the handle cover defines a recess at a lower end of the cover part, and
wherein the rim is configured to insert into the recess of the handle cover based on the handle cover closing the handle space such that a front face of the handle cover and the front face of the door cover are coplanar.

6. The dishwasher of claim 1, further comprising a driving unit configured to rotate the handle cover relative to the door, the driving unit comprising a link that is rotatably connected to the handle cover and spaced apart from the center of rotation of the handle cover.

7. The dishwasher of claim 6, wherein the driving unit further comprises:
a motor; and
a connector that is connected to the link and configured to be rotated by the motor.

8. The dishwasher of claim 6, wherein the handle cover is configured to, based on the handle cover opening the handle space, define an angle between the handle cover and the link, the angle being smaller than 90 degrees.

9. The dishwasher of claim 7, wherein a center of rotation of the connector is disposed between a motor shaft of the motor and the center of rotation of the handle cover in a vertical direction and in a front-rear direction.

10. The dishwasher of claim 1, further comprising a driving unit configured to rotate the handle cover, the driving unit comprising a motor disposed below the handle cover,
wherein the handle cover extends in a width direction of the door, and
wherein lateral ends of the handle cover in the width direction define lateral ends of the door, respectively, or the handle cover extends toward the lateral ends of the door that are spaced apart from the lateral ends of the handle cover.

11. The dishwasher of claim 10, wherein a length of the driving unit in the width direction of the door is greater than a distance between one of the lateral ends of the door and one of the lateral ends of the handle cover.

12. The dishwasher of claim 10, further comprising a spring configured to apply elastic force to the handle cover to thereby cause the handle cover to close the handle space,
wherein one of the lateral ends of the handle cover and one of the lateral ends of the door are spaced apart from each other, and
wherein the spring is disposed between the one of the lateral ends of the handle cover and the one of the lateral ends of the door.

13. The dishwasher of claim 1, further comprising a door cover that defines the front face of the door,
wherein the handle cover comprises a decoration disposed at a front side of the handle cover, and
wherein the decoration and the door cover are made of a same material and configured to be coplanar based on the handle cover closing the handle space.

14. The dishwasher of claim 1, wherein the handle further comprises a housing that is disposed inside the door and defines the handle space, and
wherein the handle cover is rotatably attached to the housing.

15. The dishwasher of claim 14, wherein the housing comprises:
a side wall; and
a guide that has an arc shape and is defined at the side wall, and
wherein the handle cover comprises:
a cover part configured to be disposed at the opening of the door based on the handle cover closing the handle space, and
a slider that is disposed at the cover part and configured to move along the guide.

16. A dishwasher comprising:
a tub that defines a washing chamber, the washing chamber being opened to a front side of the tub;
a door configured to open and close the washing chamber, the door comprising a front face having an opening;
a handle that is disposed at the door and defines a handle space connected to the opening of the door, the handle space being defined rearward relative to the opening of the door;
a handle cover disposed at the opening of the door and configured to open and close the handle space based on rotating relative to the front face of the door, the handle cover comprising an upper portion configured to move into the handle space based on the handle cover opening the handle space; and
a driving unit configured to rotate the handle cover, the driving unit comprising a motor disposed below the handle cover.

17. The dishwasher of claim 16, wherein the handle further comprises a housing that is disposed inside the door and defines the handle space, and
wherein the driving unit is disposed below the housing.

18. The dishwasher of claim 17, wherein the housing comprises:
a bottom face configured to face a rear face of the handle cover based on the handle cover opening the handle space, the bottom face defining a through-hole,
wherein the driving unit further comprises a link that passes through the through-hole and is connected to the handle cover.

19. The dishwasher of claim 17, wherein the housing further comprises:
a bottom face configured to face a rear face of the handle cover based on the handle cover opening the handle space;
a stepped portion disposed below a front end of the bottom face; and
a shaft holder that protrudes from the stepped portion, the shaft holder supporting a portion of the handle cover that defines an axis of rotation of the handle cover.

20. A dishwasher comprising:
a tub that defines a washing chamber, the washing chamber being opened to a front side of the tub;
a door configured to open and close the washing chamber, the door comprising a front face having an opening;
a handle housing that is disposed at the door and defines a handle space connected to the opening of the door, the handle space being defined rearward relative to the opening of the door;
a handle cover disposed at the opening of the door and configured to open and close the handle space based on rotating relative to the front face of the door in a first direction and a second direction, respectively, the handle cover comprising an upper portion configured to move into the handle space based on the handle cover opening the handle space; and
a driving system configured to rotate the handle cover,
wherein the driving system comprises:
a motor disposed below the handle housing and configured to rotate the handle cover in the first direction, and
a spring disposed at an outer side of the handle housing in a width direction of the door and configured to apply force to the handle cover in the second direction opposite to the first direction.
